(19) United States
(12) Patent Application Publication
(10) Pub. No.: US 2012/0016781 A1
(43) Pub. Date: Jan. 19, 2012

(54) COOKING SUPPORT SYSTEM, PROGRAM, RECORDING MEDIUM, AND METHOD FOR SUPPORTING PURCHASE AND INVENTORY MANAGEMENT OF COOKING INGREDIENTS

(76) Inventor: Hisashi Hashimoto, Aichi-ken (JP)

(21) Appl. No.: 13/257,313

(22) PCT Filed: Mar. 23, 2010
(86) PCT No.: PCT/JP2010/054925

§ 371 Date: Sep. 19, 2011

(30) Foreign Application Priority Data
Mar. 24, 2009 (JP) 2009-071440
Aug. 18, 2009 (JP) 2009-189223

(51) Int. Cl. G06Q 30/00; G06Q 50/00

(52) U.S. Cl. 705/29; 705/15

(57) ABSTRACT

In the case of supporting the purchase and the inventory management of actual foods by a user with respect to necessary foods, a function to support the purchase and the inventory management by which input operations are reduced, and a burden on the user is reduced, is realized. By providing a management method suitable for a food for cooking, the problem regarding the difference which occurs between the inventory information managed by the cooking support system and the purchased food can be solved. Further, a function to support the purchase and the inventory management of necessary foods in a management period type purchase style and in an everyday type purchase style is provided. There are a necessary food information storage means for storing necessary food information; a purchase time and date registration information editing means for editing the necessary food information to the purchase time and date registration information; a purchase time and date registration means for storing the purchase time and date in association with the necessary food information; a purchase information editing means for editing purchase information which is the information capable of being identified for respective purchase groups and purchase times and dates; and an inventory management information acquisition means for acquiring the last cooking time and date from cooking times and dates associated with the necessary food information which is associates with the same purchase group and purchase time and date, and making the acquired time and date to the cooking completion time and date which is the time and date when the inventory becomes empty.

### TECHNICAL FIELD

The present invention relates to a cooking support system, a program, a recording medium, and a method for supporting the purchase and inventory management of cooking ingredients.

### BACKGROUND TECHNOLOGY

Shaberu! DS Oryōri Navi™ has been a big hit for the Nintendo DS™, and there appears to be great demand for cooking support software (systems). Unfortunately, this software only manages menu plans. It does not support the purchase and inventory management of the necessary ingredients in menus (referred to below as the “necessary ingredients”) when the actual foods are purchased (the actual foods for the necessary ingredients are referred to below as “actual foods”).

There is personal computer software which has a function for creating a menu plan, a function for assisting with purchases by showing a shopping list, and an inventory management function to manage such things as expiration dates in which the user actually enters information related to the purchase of actual foods. However, in order to manage inventories, the user has to separately enter information related to the purchase of actual foods. The user also has to enter information when the actual food has been used up. This places a heavy management burden on the user.

There are also systems assisting in the purchase and inventory management of materials such as industrial parts, but the cooking ingredients that are managed in the system of the present invention are different from materials such as industrial parts, as many cooking ingredients can be substituted with similar cooking ingredients. For example, pork medallions can be used instead of pork loin. When cooking ingredients are managed separately, they are processed using inventories of other cooking ingredients in case of substitution. Thus, when actual foods are used, there are discrepancies (or the appearance of discrepancies from the standpoint of the user) between inventory information managed by a cooking support system and purchased ingredients.

There are also different purchasing styles for food. For example, there is a purchasing style in which a user goes to the market each day to purchase (procure, buy) fresh food (referred to below as the “day-to-day purchasing style”). A management period is established for one week, for example, from lunch on Saturday to breakfast on the next Saturday, and purchases (bulk purchases, bulk procurement) before lunch on Saturday, which is the start of the management period, are focused on (actual foods corresponding to) (perishable) necessary ingredients for use in cooking during the management period based on their expiration date (or freshness deadline). There is another purchasing style in which (actual food corresponding to) the rest of the ingredients (for example, necessary ingredients which could not be used or consumed by their expiration date) can be purchased (procured, bought) at the supermarket on a later date (referred to below as the “management period purchasing style”). The management period purchasing style is especially suitable for the purchase of cooking ingredients over the internet. Because there are shipping costs when cooking ingredients are purchased over the internet, it is uneconomical for daily purchases. Unfortunately, no cooking support software is currently available which supports both of these purchasing styles. When the management period purchasing style is supported, cooking ingredients have to be purchased in bulk by the initial date of the management period. However, if a date near but after the initial date of the management period is a sale date, some purchases should be made by the initial date of the management period but the bulk of the cooking ingredients should be purchased in bulk on the sale date. Software should allow for such exceptions.

### SUMMARY OF THE INVENTION

### Problem Solved by the Invention

In view of this situation, an object of the present invention is to realize functions which assist a user in the purchase and inventory management of actual foods which are necessary ingredients, and which assist with purchasing and inventory management while reducing input operations and reducing the burden on the user. Also, an object of the present invention is to provide a management method applicable to cooking ingredients which eliminates discrepancies between inventory information managed by a cooking support system and purchased ingredients. Another object of the present invention is to provide functions which assist in the purchase and inventory management of necessary ingredients using the management period purchasing style or the day-to-day purchasing style.

### Means of Solving the Problem

The present invention has the following characteristics, which are means for solving the problem mentioned above.

A first aspect of the present invention is a cooking support system for providing a meal planning and management support function, an ingredient purchase support function, and an inventory management support function, characterized in comprising:

a computer processor means for data processing, a recording medium, a recording means for recording data on the recording medium, a display means for outputting processing results, and an input means for inputting information to the cooking support system, the cooking support system further comprising:

a necessary ingredient information storing means for storing in the recording medium as menu planning information at least necessary ingredient information being information on the ingredients necessary for cooking, the necessary ingredient information being linked to the cooking date and time and to a purchasing table assembling ingredients based on an assembly of one or more substitutable ingredients;

a purchase date and time registration information editing means using the computer processor means to edit based on the necessary ingredient information storing means the necessary ingredient information as purchase date and time registration information being information to be referenced when the user registers the purchase date and time, and to output the edited information from the display means;

a purchase date and time registration means allowing the user to input from the input means information identifying the purchase date and time corresponding to the necessary ingredient information while referencing the purchase date and time registration information, and storing in the necessary ingredient information storing means purchase dates and times being dates and times prior to the cooking dates and times linked to the necessary ingredient information based on inputted information and using the recording means;

a purchase information editing means using the computer processor means to edit purchase information to be referenced when the user makes purchases based on the necessary ingredient information storing means so information related to necessary ingredients can be identified by purchase group and purchase date and time, and to output the edited information from the display means; and

an inventory management information acquiring means for acquiring the final cooking date and time within the cooking dates and times linked to necessary ingredient information linked, in turn, to the same purchase group and purchase date and time as the cooking end date and time being the date and time the necessary ingredient is to run out in the inventory based on the necessary ingredient information storing means using a computer processor means.

A second aspect of the present invention is the cooking support system of claim 1 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date, and for not changing the management period after being linked to necessary ingredients whose purchase date and time are registerable and the purchase dates and times have been stored;

wherein the cooking support system has a management period storing means for storing a management period being the management reference period when the user purchases ingredients and manages inventory;

wherein the purchase date and time registration information editing means uses management period purchase reference dates and times being dates and times within the management period for purchase reference;

wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;

wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;

wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;

and wherein the inventory management information editing means determines using the computer processor means and the inventory aggregate information at least whether or not all times within the inventory presence period are within the management period, and when the condition is satisfied edits the information so as to be identifiable as inventory aggregate information for supporting a management period purchasing style.

A third aspect of the present invention is the cooking support system of claim 1 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date;

wherein the cooking support system has a management period storing means for storing a management period being the management reference period when the user purchases ingredients and manages inventory;

wherein the purchase date and time registration information editing means uses management period purchase reference dates and times being dates and times within the management period for purchase reference;

wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;

wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;

wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;

and wherein the inventory management information editing means determines using the computer processor means and the inventory aggregate information at least whether or not a certain time within the inventory presence period is within the management period, and when the condition is satisfied edits the information so as to be identifiable as inventory aggregate information for supporting a management period purchasing style.

A fourth aspect of the present invention is the cooking support system of claim 1 for supporting a day-to-day purchasing style being a purchasing style for purchasing fresh ingredients on a daily basis;

wherein the purchase date and time registration information editing means uses purchase reference dates and times being dates and times for purchase reference;

wherein the computer processor means based on the necessary ingredient information storing means and the necessary ingredient information at least determines whether or not a condition is satisfied being that the purchase reference dates and times are within the management period, the purchase date and time registration information being edited when the condition is satisfied so as to be identified as necessary ingredient information in which the purchase dates and times can be registered or updated as purchase dates and times, or as purchase date and time registerable necessary ingredient information for supporting a day-to-day purchasing style;

wherein the purchase date and time registration means allows the user to input from the input means information for identifying purchase date and time registerable necessary ingredient information for purchases at the purchase reference dates and times among the identifiable purchase date and time registerable necessary ingredient information, the purchase date and time registration means using the input means and input information to link purchase reference dates and times as purchase dates and times to the purchase date and time registerable necessary ingredient information and storing the linked information;

wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;

and wherein the inventory management information editing means determines using the computer processor means, the inventory aggregate information, and inventory decision reference dates and times being dates and times referenced for decisions when verifying inventory status, at least whether or not the inventory decision reference dates and times are within the period from (purchase dates and times minus specified period prior to inventory presence period) to (cooking end dates and times plus specified period prior to inventory presence period), and when the condition is satisfied edits the information so as to be identifiable as inventory aggregate information for supporting a day-to-day purchasing style.

### EFFECTS OF THE INVENTION

The cooking ingredient support system in the first aspect assists a user with the purchase and inventory management of actual foods which are necessary ingredients, and assists with purchasing and inventory management while reducing input operations and reducing the burden on the user. More specifically, the user simply registers the purchase date and time, which is a date and time prior to the cooking date and time, for each necessary ingredient. Information organized by purchase group and purchase date and time can then be referenced (referred to below as “purchase information”). Actual food is purchased corresponding to the purchase information (while checking the purchase information), and inventory management can be performed based on inventory information aggregated by purchase group and purchase date and time (referred to below as “inventory aggregate information”) which allows for confirmation of the period in storage (referred to below as the “inventory presence period”). When inventory information is managed by purchase group and purchase date and time, actual food can be used and discrepancies (or the appearance of discrepancies from the standpoint of the user) can be eliminated between inventory information managed by the cooking support system and purchased ingredients.

In an application example, when actual food is ordered over the internet, the first aspect is used to link the information on the actual food in the transaction record to inventory aggregate information by purchase group and purchase date and time, and the linked information is stored. This allows actual food to be managed based on the inventory presence period. This also eliminates the need to enter the fact that actual food has been used.

The cooking ingredient system in the second aspect can support the management period purchasing style. More specifically, the cooking ingredient system edits necessary ingredient information enabling registration of the purchase date and time for supporting the management period purchasing style. This necessary ingredient information is determined in accordance with the management period. The edited information includes identification information helping the user to register purchase dates and times, and identification information allowing the user to identify inventory aggregation information for supporting the management period purchasing style determined in accordance with the management period. Thus, a function is realized that supports the management period purchasing style of the user. This aspect can be used when there is no chance that the management period will be changed.

The cooking ingredient system in the third aspect can support the management period purchasing style. More specifically, as in the second aspect, the cooking ingredient system edits necessary ingredient information enabling registration of the purchase date and time for supporting the management period purchasing style. This necessary ingredient information is determined in accordance with the management period. The edited information includes identification information helping the user to register purchase dates and times, and identification information allowing the user to identify inventory aggregation information for supporting the management period purchasing style determined in accordance with the management period. Thus, a function is realized that supports the management period purchasing style of the user. However, this aspect is not used when there is no possibility that the management period will be changed. It can be used even when there is a possibility that the management period will be changed.

The cooking ingredient system in the fourth aspect can support the day-to-day period purchasing style. More specifically, the cooking ingredient system edits necessary ingredient information enabling registration of the purchase date and time for supporting the day-to-day period purchasing style. This necessary ingredient information is determined in accordance with a purchase reference date and time, which is the date and time used to reference the purchase (procurement). The edited information includes identification information helping the user to register purchase dates and times, and identification information allowing the user to identify inventory aggregation information for supporting the day-to-day purchasing style determined in accordance with an inventory decision reference date and time, which is a date and time used to reference a decision when the inventory status was confirmed. Thus, a function is realized that supports the day-to-day purchasing style of the user.

### BRIEF EXPLANATION OF THE FIGURES

FIG. 1 is a block diagram showing the hardware configuration.

FIG. 2 is a block diagram showing an example of a database configuration.

FIG. 3 is a data flow diagram (DFD) used to explain the first through third operational examples.

FIG. 4 is an example of a purchase date and time registration information screen in the first operational example.

FIG. 5 is an example of a purchase information screen in the first operational example.

FIG. 6 is an example of a flowchart used by the key switching process when purchase information is edited.

FIG. 7 is an example of an inventory management information screen in the first operational example.

FIG. 8 is an example of a flowchart used by the key switching process when inventory management information is edited.

FIG. 9 is an example of data in the management period TBL 1413.

FIG. 10 is an example of a purchase date and time registration information screen in the second operational example.

FIG. 11 is an example of an inventory management information screen in the second operational example.

FIG. 12 is an example of data in the management period TBL 1413.

FIG. 13 is an example of a purchase date and time registration information screen in the second operational example.

FIG. 14 is an example of an inventory management information screen in the second operational example.

FIG. 15 is an example of a purchase date and time registration information screen in the third operational example.

FIG. 16 is an example of a purchase date and time registration information screen in the third operational example.

FIG. 17 is an example of an inventory management information screen in the third operational example.

### MODE FOR CARRYING OUT THE INVENTION

The following is an explanation of embodiments of the present invention with reference to the figures.

### 1. Example of a Hardware Configuration For the System in the Present Invention.

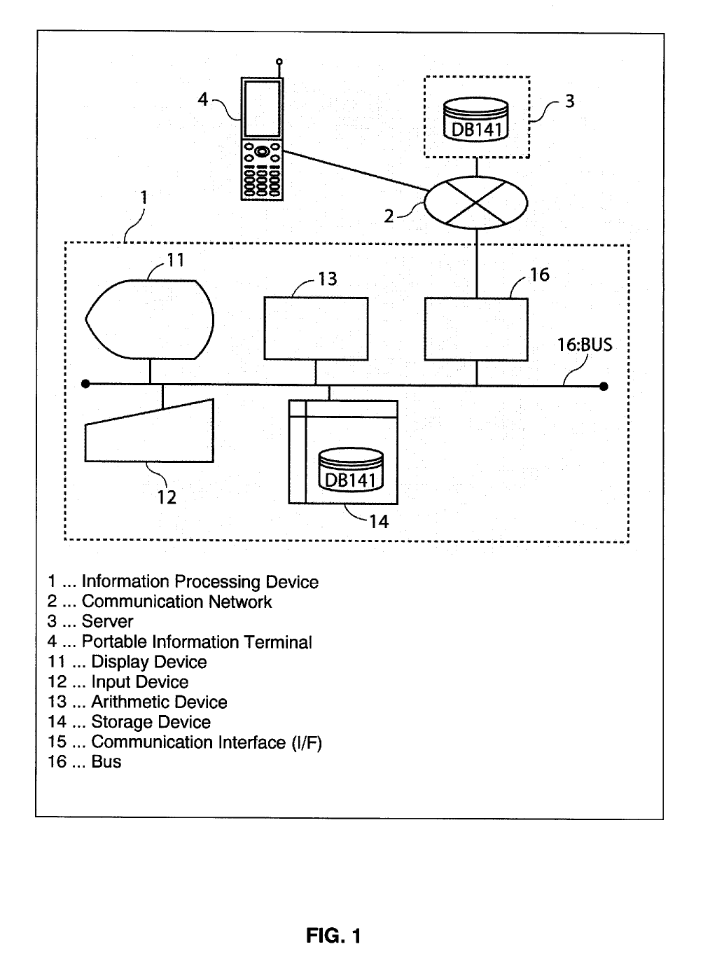

The following is an explanation of the hardware configuration for the system in an embodiment of the present invention. FIG. 1 is block diagram showing the hardware configuration for the system in an embodiment of the present invention.

As shown in the figure, the system of the present invention at least comprises an information processing device 1 connected by a bus (BUS) 16 to a display device 11 composed of a display and speakers (sound-generating device) or a printer for displaying the various types of data, an input device 12 such as a keyboard, mouse or voice input device for entering various types of data, an arithmetic device (computer processor) 13 for performing various calculations and data processing, and a storage device 14 such as memory or a hard disk for storing processing programs and data (databases). More specifically, a personal computer, portable telephone, or personal digital assistant (PDA) can be used.

Here, the various types of programs and data stored in the storage device 14 can also be stored in the server 3. In addition, the processing performed by the arithmetic device 13 can also be performed by the server 3. The server 3 has an arithmetic device (computer processor) for performing various types of arithmetic operations, a storage device such as memory or a hard disk for storing processing programs and data (databases), and a communication interface (I/F) connected via a bus (BUS). More specifically, it is a computer typically available in a server. It does not have to be installed in a single case. A plurality of computers can be assembled to compose a server having a group of computers for distributed processing. When a server 3 is installed, the information processing device 1 is connected to a communication network such as the internet via the communication I/F 15 serving as the communication means. Similarly, communication is established with the server 3 over a communication network such as the internet.

In other words, when a stand-alone system is established, it is realized by the information processing device 1. When a client server system is established, it is realized by connecting an information processing device 1 serving as the client to the server 3 via a communication network 2.

Instead of a display device 11, email can be used to send processing results from an information processing device 1 or server 3 to a portable information terminal 4, where it is displayed on the portable information terminal 4 (or presented audibly). In other words, a portable information terminal can be used as the display means. Examples of portable information terminals 4 include portable telephones and personal digital assistants (PDAs).

The relationship to the claims will now be clarified. The computer processor means in the claims corresponds to an arithmetic device 13 in an information processing device 1 or an arithmetic device in a server 3. The recording medium and recording means in the claims correspond to a storage device 14 in the information processing device 1 or to a storage device in a server 3. The display means in the claims corresponds primarily to a display device 11 in an information processing device 1. However, as mentioned earlier, a personal information terminal 4 can also be used as the display device in the claims. The input means in the claims corresponds to an input device 12.

### 2. An Example of a Database Configuration For a System of the Present Invention

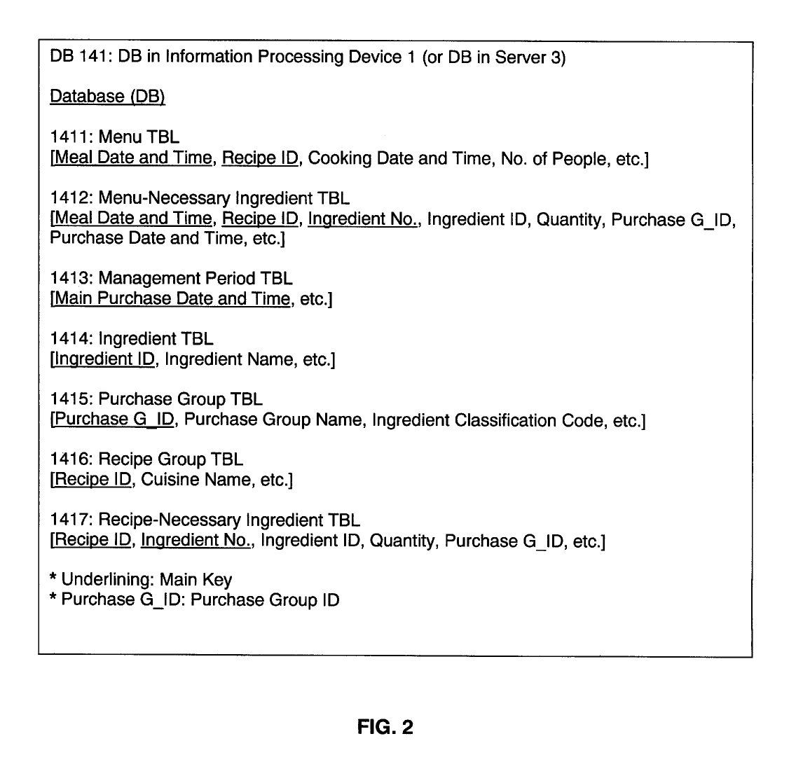

The following is an explanation of a database configuration for the system in an embodiment of the present invention. FIG. 2 is a block diagram showing an example of a database (DB) configuration for the system in an embodiment of the present invention. Tables (TBL) and attributes not directly related to the present invention have been omitted. In FIG. 2 and the explanation of the various TBLs below, the main key of each TBL is underlined.

### 2.1. DB 141

In FIG. 2, DB 141 is a DB installed in the information processing device 1 or in the server 3. When data for a plurality of users is managed by the same system, the data for each user is separate and TBLs are established for each user. A user ID is also added to the attributes.

### 2.1.1. Menu TBL 1411

The menu TBL 1411 is a TBL for storing menu plans. Its attributes include “meal date and time” which is the date and time cuisine indicated by a recipe ID is to be eaten, “recipe ID” which is information indicating cuisine (cuisine recipe), “cooking date and time” which is the date and time cuisine is to be cooked, and “number of people” which is the number of people to be served the cuisine. When “meal date and time=cooking date and time”, the cooking date and time can be substituted by the meal date and time.

Here, the cooking date and time and the meal date and time are combined with an actual date and time (e.g., 2008/05/08, 2 (dinner)). In this embodiment, the time can be assigned numerically with 0 representing breakfast, 1 representing lunch, and 2 representing dinner. The numerical order assigned to breakfast, lunch and dinner can also match the actual time of the day. In the system of the present invention, the processing includes a comparison operation using the purchase date and time, cooking date and time, and meal date and time. A snack and late-night meal can also be added. Here, 0 represents breakfast, 1 represents lunch, 2 represents a snack, 3 represents dinner, and 4 represents a late-night meal. Values approximating actual times can also be used. For example, 7 represents breakfast, 12 represents lunch, 15 represents a snack, 19 represents dinner, and 23 represents a late-night meal.

The system does not divide time smaller than single hour increments. If a purchase has to be made between cooking dates and times, it can be made one hour before lunch or two hours after lunch. It makes no difference from the standpoint of management in the system of the present invention. There are no unnecessary restrictions on the purchase times of the user as long as the system includes the data. Also, it is linked to the recipe TBL 1416 by the recipe ID.

### 2.1.2. Menu-Necessary Ingredient TBL 1412

The menu-necessary ingredient TBL 1412 is a TBL for storing information related to ingredients needed to prepare cuisine based on a menu plan. Its attributes include meal date and time, recipe ID, “ingredient No” which is information for dividing necessary ingredients by cuisine, “ingredient ID” which is information linked to the ingredient TBL 1414, “quantity” which is the quantity of cuisine per person, “purchase group ID” which is information linked to the purchase group TBL 1415, and “purchase date and time” which is the date and time at which the actual food corresponding to the necessary ingredient was purchased. Here, the menu-necessary ingredient TBL 1412 is linked by the “meal date and time” and the “recipe ID” to the menu TBL 1411.

The actual quantity needed is calculated using the quantity in the menu-necessary ingredient TBL 1412 multiplied by the number of people in the menu TBL 1411. It does not have to have “ingredient name”. Also, “ingredient ID” is not required.

The purchase date and time are combined with an actual date and time (e.g., 2008/05/08, 2 (dinner)). In this embodiment, the purchase date and time are managed so as to be before a meal (or before cooking). For example, 0 represents before breakfast (or before preparation of breakfast), 1 represents before lunch (or before preparation of lunch), and 2 represents before dinner (or before preparation of dinner). The purchase date and time are managed as before a meal (or before preparation) because purchases and inventory are not checked when a meal is served (or prepared) but between two consecutive meals (or meal preparations) or after a meal has been served (or prepared) with the objective being a subsequent meal (or meal preparation). A numerical value is assigned which corresponds to a cooking date and time and a meal date and time managed by the menu TBL 1411. For example, when 2 is assigned as the cooking date and time or the meal date and time, 2 is also assigned as before dinner in the purchase date and time. In this embodiment, the time for the cooking date and time and the meal date and time can be managed using 0 for breakfast, 1 for lunch, and 2 for dinner. In this case, the time for the purchase date and time are 0 for before breakfast (or before breakfast preparation), 1 for before lunch (or before lunch preparation), and 2 for before dinner (or before dinner preparation). Because the purchase date and time are before the cooking date and time, a numerical value such as 1.9 cannot be used. This is because the processing in the system of the present invention includes a comparison operation using the purchase date and time, the cooking date and time, and the meal date and time.

Before a snack and before a late-night meal can also be added. Here, when the time for the cooking date and time and the meal date and time are 0 for breakfast, 1 for lunch, 2 for snack, 3 for dinner, and 4 for late-night meal, the time for the purchase date and time are 0 for before breakfast, 1 for before lunch, 2 for before snack, 3 for before dinner, and 4 for before the late-night meal. When the former uses 7 for breakfast, 12 for lunch, 15 for snack, 19 for dinner, and 23 for late-night meal, the latter uses 7 for before breakfast, 12 for before lunch, 15 for before snack, 19 for before dinner, and 23 for before the late-night meal.

When information stored in the menu-necessary ingredient TBL 1412 is deleted, the registered purchase date and times can be deleted by purchase group ID and purchase date and time. When organized by purchase group ID and purchase date and time, incomplete information can be prevented.

### 2.1.3 Management Period TBL 1413

The management period TBL 1413 is a TBL for recording the management period. Its attributes include “main purchase date and time”. The main purchase date and time corresponds to the initial purchase date and time in the management period, and is the date and time for the bulk purchase of the necessary ingredients for the management period. Two consecutive main purchase dates and times form the management period which starts after the first main purchase date and time and ends before the next main purchase date and time. In other words, the management period is “prior main purchase date and time≦management period<subsequent main purchase date and time”.

Here, the main purchase date and time are combined with an actual date and time (e.g., 2008/05/08, 2 (dinner)). In this embodiment, as in the case of the purchase date and time described above, the main purchase date and time are managed as before a meal (or before preparation). For example, 0 represents before breakfast (or before preparation of breakfast), 1 represents before lunch (or before preparation of lunch), and 2 represents before dinner (or before preparation of dinner). At this time, a numerical value is assigned which corresponds to a cooking date and time and a meal date and time managed by the menu TBL 1411. For example, when 2 is assigned as the cooking date and time or the meal date and time, 2 is also assigned as before dinner in the main purchase date and time. In this embodiment, the time for the cooking date and time and the meal date and time can be managed using 0 for breakfast, 1 for lunch, and 2 for dinner. In this case, the time for the main purchase date and time are 0 for before breakfast (or before breakfast preparation), 1 for before lunch (or before lunch preparation), and 2 for before dinner (or before dinner preparation). Because the purchase date and time are before the cooking date and time, a numerical value such as 1.9 cannot be used. This TBL is used in the second operational example described below.

The management period is the same as “prior main purchase date and time≦management period<subsequent main purchase date and time” or “prior main purchase date and time≦management period≦date and time prior to subsequent main purchase date and time (final date and time of management period beginning with prior main purchase date and time)”.

### 2.1.4. Ingredient TBL 1414

Ingredient TBL 1414 is the TBL for storing information related to cooking ingredients. This has attributes such as “ingredient ID” and “ingredient name”. The purchase group IDs used in the menu-necessary ingredient TBL 1412 should also be used in this TBL. Instead of using this TBL, a menu-necessary ingredient TBL 1412 or a recipe-necessary ingredient TBL 1417 can have ingredient names.

### 2.1.5. Purchase Group TBL 1415

Purchase group TBL 1415 is a TBL for storing information related to purchase groups. Its attributes include “purchase group ID”, “purchase group name”, and “ingredient classification code”, which is a code indicating the ingredient classification (meat, seafood, vegetables). Here, the purchase group is a group indicating a purchasing unit. It is an aggregate of ingredients for which there is one or more substitutable ingredients (usually one but often two or more). The following is an easy to understand example. When an order of actual ingredients is placed by a user using the system in the present invention, purchased ingredients are linked to a group as a purchasing unit (usually one but often two or more). When an ingredient has one or more similar substitutable ingredients (usually one but often two or more), its group corresponds to a purchase group in the system of the present invention.

Cuisine ingredients which are subject to management in the system of the present invention differ from materials such as industrial components in that there are many similar ingredients that can serve as substitutes. One reason is ingredients are actually purchased in quantities that do not match as the necessary quantities are determined based on recipes. When a similar ingredient or substitutable ingredient is needed in other recipes, the necessary quantities for these recipes must be taken into account when purchasing the ingredients so that none of it goes to waste. In a specific example, when 200 g of pork loin are needed in cuisine A, and 100 g of pork medallions are needed in cuisine B, and when 320 g of pork loin has been purchased, the pork medallions in cuisine B can be substituted by pork loin. This serves as the premise for purchasing the 320 g of pork loin. (The remaining 20 g can be split between cuisine A and cuisine B to slightly increase the portions.) When these ingredients are managed separately, the ingredients are processed and stored separately even in the case of substitutions. When actual ingredients are used, there are discrepancies (or the appearance of discrepancies from the standpoint of the user) between inventory information managed by the system of the present invention and purchased ingredients. When similar substitutable ingredients are placed in a purchase group, the ingredients are not processed and stored separately from the standpoint of substitution. However, overly precise grouping causes problems such as not knowing which purchase group to use for an ingredient. Excessive attention to grouping should thus be avoided. By carefully grouping ingredients in purchase groups and combining the groups with the processing described below, the appropriate management of ingredients can be realized.

A purchase group is an aggregation with more than one similar, substitutable ingredient. However, when there are too many purchase groups, the operation of the system and the processing performed by the system become complicated. For example, when the user registers necessary ingredient information for a recipe (managed in this embodiment using the recipe-necessary ingredient TBL 1417), the user has to register a purchase group ID for each one of the necessary ingredients. When there are too many purchase group IDs, a great burden is placed on the user. When there is a plurality of purchase groups, a single purchase group can experience problems associated with excessive grouping. In order to eliminate these problems, a plurality of purchase groups are assembled in the same system and organization is performed using a single purchase group. In other words, purchase groups are aggregates based on one or more similar and substitutable ingredients. An example of single purchase group among a plurality of purchase groups could include mutton chops, mutton loin, crocodile breast, and crocodile tail. When these similar and substitutable ingredients are grouped, the mutton chops and mutton loin could be grouped under “mutton”, and the crocodile breast and crocodile tail could be grouped under “crocodile”. If the frequency of use is high and aggregates are grouped in different purchase groups, there is a chance that purchase groups will proliferate. It is easier to create a purchase group called “other meat” for mutton and crocodile. It is easy, for example, to create purchase groups for meat called “pork”, “beef”, “chicken”, “ground meat”, and “other meat”. Care should be exercised to create abstract, generic purchase groups such as “other meats”. In this way, when managed ingredients are added in the future, a new purchase group does not have to be added, and the ingredients can be managed using an existing abstract, generic purchase group. This also reduces the possibility that purchase groups will have to be reorganized. For example, when an ingredient such as frog legs are to be managed, a new purchase group called “frog meat” does not have to be added. It can simply be added to an existing purchase group called “other meat”.

For example, one classification method for ingredients would be to use the food groupings in the Standard Tables of Food Composition for Japan in the Resource Survey Subcommittee Report of the Science and Technology Committee of the Ministry of Education, Culture, Sports, Science and Technology. This does not have to be used in every respect. For example, milk products could be further classified by milk and cheese. Because milk and cheese are not substitutable, they should be in separate purchase groups. Similar fine adjustments should be made to the food groupings in the Standard Tables. Even though these adjustments add another purchase group to existing purchase groups, further classification such as creating separate purchase groups for milk and cheese should cause no problem because they do not make the system more difficult to use.

Vegetables can be classified by leafy vegetables such as spinach, stem vegetables such as onions, root vegetables such as radishes, and fruit vegetables such as tomatoes. However, this system would leave several difficult-to-classify items remaining such as frozen mixed vegetables, and packages of cut mixed vegetables. In light of this situation, it is important to remain focused on intended use and to create groups of similar, substitutable (or nearly substitutable) items. The eventual purchase groups have to make the system easy for the user to continue using.

Another example of an inappropriate classification for a purchase group is to classify ingredients by attributes such as perishability. When beef fillets, spinach, and milk are placed in a group for fresh ingredients, and beef strips, carrots and yogurt are placed in a group for perishable ingredients, it is difficult to determine which ingredients between these groups are substitutable. In other words, purchase groups are difficult to create using this classification method. Other examples of classification systems that do not make for appropriate purchase groups that indicate similar, substitutable ingredients include classification by place of origin, classification by genetic modification, classification by color, and classification by sugar content.

As a general rule, a single ingredient should not be placed in a plurality of purchase groups (although there will always be exceptions). For example, milk is sometimes purchased as a drink and sometimes purchased for cooking, such as baking cookies or cake and making cream stew. Here, different types of milk are used (and they are managed separately). Milk intended for drinking can be categorized separately (“drinking milk”) and placed in a purchase group with soy milk, yogurt drinks, and juices. Milk intended for cooking can also be categorized separately as cooking milk for cookies, cakes and stews, and placed in a purchase group with evaporated milk, etc. Because the drinking milk and cooking milk are classified by use, they are considered separate ingredients. When drinking milk and cooking milk are managed simply as milk, it should be categorized based on higher frequency of use or higher degree of substitutability between drinking and cooking. A separate purchase group called “milk” can also be created. Milk is then placed in this purchase group whether it is used for drinking or for cooking.

Even though the word milk is used, the milk aggregate includes many different substitutable types of milk such as low-fat milk and whole milk. Similarly, in the case of another ingredient, when a purchase group called “carrots” is established, it is an aggregate including many different substitutable types of carrots such as carrots and minicarrots. When ingredients are grouped by purchase group, the aforementioned advice should be taken into account.

### 2.1.6. Recipe TBL 1416

The recipe TBL 1416 is a TBL for storing information related to recipes. Its attributes include “recipe ID”, and “cuisine name”. This table is linked by recipe ID to the menu TBL 1411 and the menu-necessary ingredient TBL 1412.

### 2.1.7. Recipe-Necessary Ingredient TBL 1417

The recipe-necessary ingredient TBL 1417 is a TBL for storing information related to necessary ingredients. Its attributes include “recipe ID”, “ingredient No” which differentiates necessary ingredients by cuisine, “ingredient ID” which is information linked to ingredient TBL 1414, “quantity” which indicates the amount per person, and “purchase group ID” which is information linked to purchase group TBL 1415. Here, menu-necessary ingredient TBL 1412 is linked to recipe TBL 1416 by recipe ID.

“Ingredient name” can also be added. In this situation, “ingredient ID” is not required.

### 3. Operational Example of the System in the Present Invention

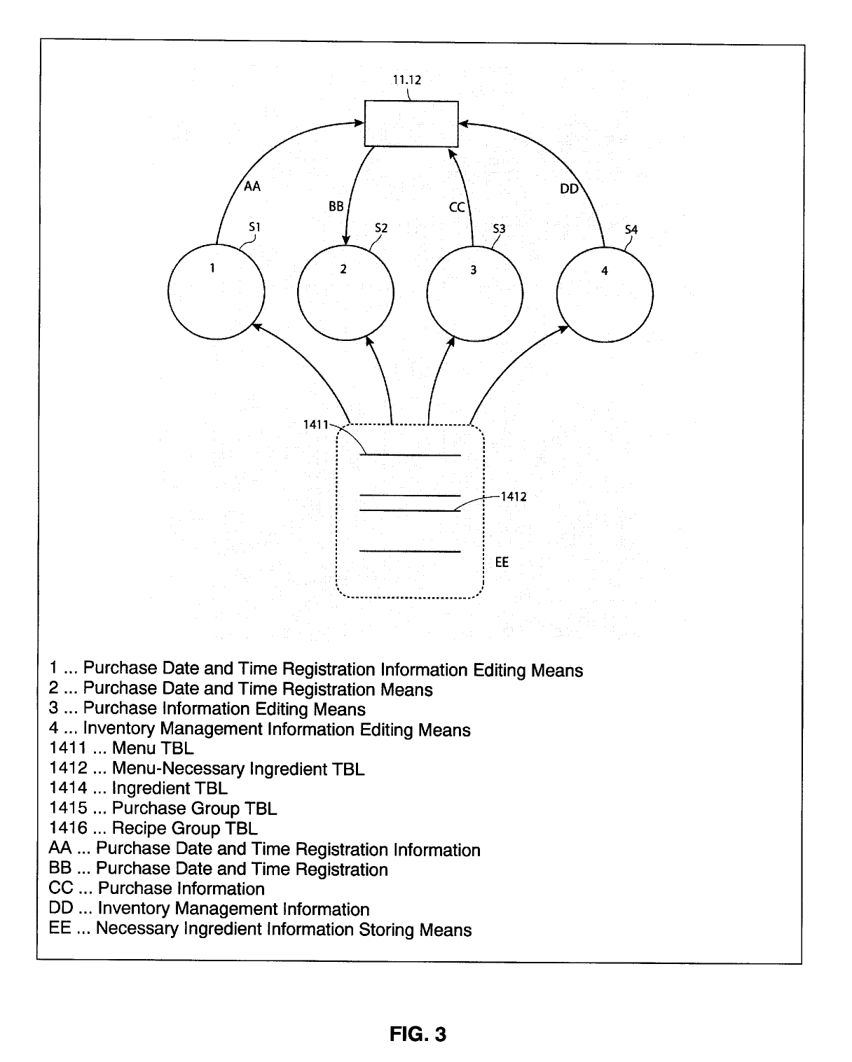

FIG. 3 is a data flow diagram (DFD) used to explain the first through third operational examples. The purchase date and time registration information editing means in S1 (Step 1) of FIG. 3 corresponds to the purchase date and time registration information editing means in the claims. The date and time registration in S2 (Step 2) of FIG. 3 corresponds to the purchase date and time registration means in the claims. The purchase information editing means in S3 (Step 3) of FIG. 3 corresponds to the purchase information editing means in the claims. The inventory management information editing means in S4 (Step 4) of FIG. 3 corresponds to the inventory management information editing means in the claims. The necessary ingredient information storing means in FIG. 3 corresponds to the necessary ingredient information storing means in the claims.

### 3.1. First Operational Example

The first operational example covers the basic operations of the system in the present invention.

### 3.1.1. Necessary Ingredient Information Storing Means

The necessary ingredient information storing means is a means for storing necessary ingredient information as menu planning information.

In this embodiment, the necessary ingredient information is stored primarily in menu TBL 1411 and menu-necessary ingredient TBL 1412. This can be verified using the necessary ingredient information storing means in FIG. 3. The menu-necessary ingredient information TBL 1412 is linked to the menu TBL 1411 by meal dates and times and by recipe ID. It also has purchase dates and times and purchase group IDs. In the initial stage, the purchase date and time are not registered (NULL value). The ingredient TBL 1414 and the menu-necessary ingredient TBL 1412 are linked by ingredient ID. The purchase group TBL 1415 and the menu-necessary ingredient TBL 1412 are linked by purchase group ID. The recipe TBL 1416 and the menu TBL 1411, and the recipe TBL 1416 and the menu-necessary ingredient TBL 1412 are linked by recipe ID. These TBLs are linked to obtain necessary ingredient information.

Registration of menu plan information in the menu TBL 1411 and the menu-necessary ingredient TBL 1412 is performed using the function for creating a menu plan (the menu plan creating means). More specifically, a recipe ID, meal date and time, cooking date and time, and the number of people are received from the input device 12, and the received information is stored in the menu TBL 1411 and the menu-necessary ingredient information TBL 1412 based on the recipe TBL 1416 and the recipe-necessary ingredient TBL 1417.

### 3.1.2. Purchase Date and Time Registration Information Editing Means

The purchase date and time registration information editing means is the means for editing the necessary ingredient information to supplement the registration operations performed by the user using the purchase date and time registration means (described below).

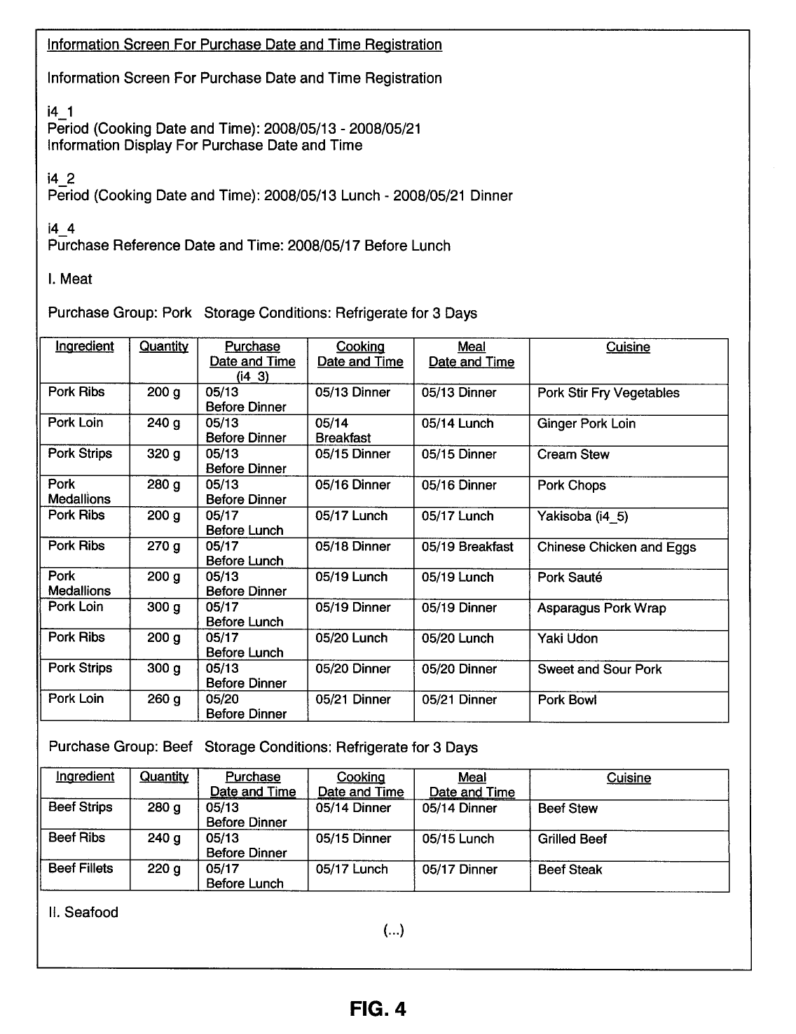

FIG. 4 is an example of a purchase date and time registration information screen. When the user sets a certain period of time in i4_1 (FIG. 4) and the purchase date and time registration display button is pressed, the system of the present invention in S1 (FIG. 3) extracts the necessary ingredient information from the necessary ingredient information storing means that satisfies the requirement “the cooking date and time are within the time period” indicated by i4_1 (FIG. 4). Sorting is performed by purchase group ID, cooking date and time and ingredient ID (the sorting priority is from left to right) or by purchase group ID, ingredient ID, and cooking date and time (the sorting priority is from left to right). Thus, organization is performed by purchase group, and the purchase date and time registration information is edited and displayed in i4_2 (FIG. 4). At this time, organization is performed by purchase group, but the user can edit the result based on purchase date and time decisions for the various necessary ingredients. For example, sorting can be performed based on cooking date and time and by cuisine. Sorting by purchase group, cooking date and time, and cuisine can be realized using the key switching process. A relational database function can also be used. In the screen example shown in FIG. 4, the sorting is performed by ingredient type (ingredient category code) such as meat or seafood. In other words, the sorting should be performed by purchase group using the purchase group ID.

### 3.1.3. Purchase Date and Time Registration Means

The purchase date and time registration means allows the user to link purchase dates and times to necessary ingredient information and to store the linked information.

Next, the user registers a purchase date and time that satisfies the condition “purchase date and time≦ cooking date and time” in i4_3 (FIG. 4) for each necessary ingredient in the purchase date and time registration information displayed in i4_2 (FIG. 4). Then, the system of the present invention, in S2 (FIG. 3), receives the information indicating the necessary ingredient information and the purchase date and time, links this to the necessary ingredient information in the menu-necessary ingredient TBL 1412 based on the received information, and stores the purchase date and time. At this time, information indicating the necessary ingredient information and the purchase date and time has to be received. However, it can also be information indicating a purchase date and time corresponding to various necessary ingredients. The system of the present invention uses information and algorithms stored beforehand to identify purchase dates and times corresponding to various necessary ingredients. For example, quality control information in the form of a number of days is linked beforehand to purchase group IDs linked, in turn, to necessary ingredients and stored in the storage device 14. Here, a purchase date and time and a purchase group ID are received instead of information identifying necessary ingredients and a purchase date and time. The system of the present invention then calculates the cooking date and time (or meal date and time) from the purchase date and time, and determines whether or not the necessary ingredient matches the purchase group ID is within the quality assurance period. In other words, it can determine whether or not the necessary ingredient matches the purchase group ID so as to satisfy the condition “received purchase date and time≦cooking date and time (meal date and time) for the necessary ingredient≦received purchase date and time+quality assurance period linked to received purchase group ID”. If so, it is linked and the received purchase date and time are stored. Alternatively, the purchase date and time can be received alone. It is then linked to necessary ingredients satisfying the condition “received purchase date and time≦cooking dates and times (meal dates and times) for the various necessary ingredients≦received purchase date and time+quality assurance period linked to received purchase group IDs for the various necessary ingredients”. The received purchase date and time are linked, and the linked information is stored.

A purchase date and time have to be prior to the cooking date and time (“purchase date and time≦cooking date and time”).

When data is stored in the server 3, the validity of the values should also be checked by the server 3.

In another example, the purchase date and time registration information editing means prints on paper information on the necessary ingredients assigned an ID identifying the necessary ingredient, and the purchase date and time registration means prepares an interface for the input of IDs, purchase dates and times, and text. The user inputs the information using the interface, and the purchase dates and times are linked to necessary ingredients and stored based on input information.

### 3.1.4. Purchase Information Editing Means

The purchase information editing means is a means for editing purchase information to be referenced when the user makes purchases. In purchase information, the user edits information related to the necessary ingredients so that the information can be identified (recognized) by purchase group and purchase date and time. This helps the user make purchases using purchase groups and purchase dates and times.

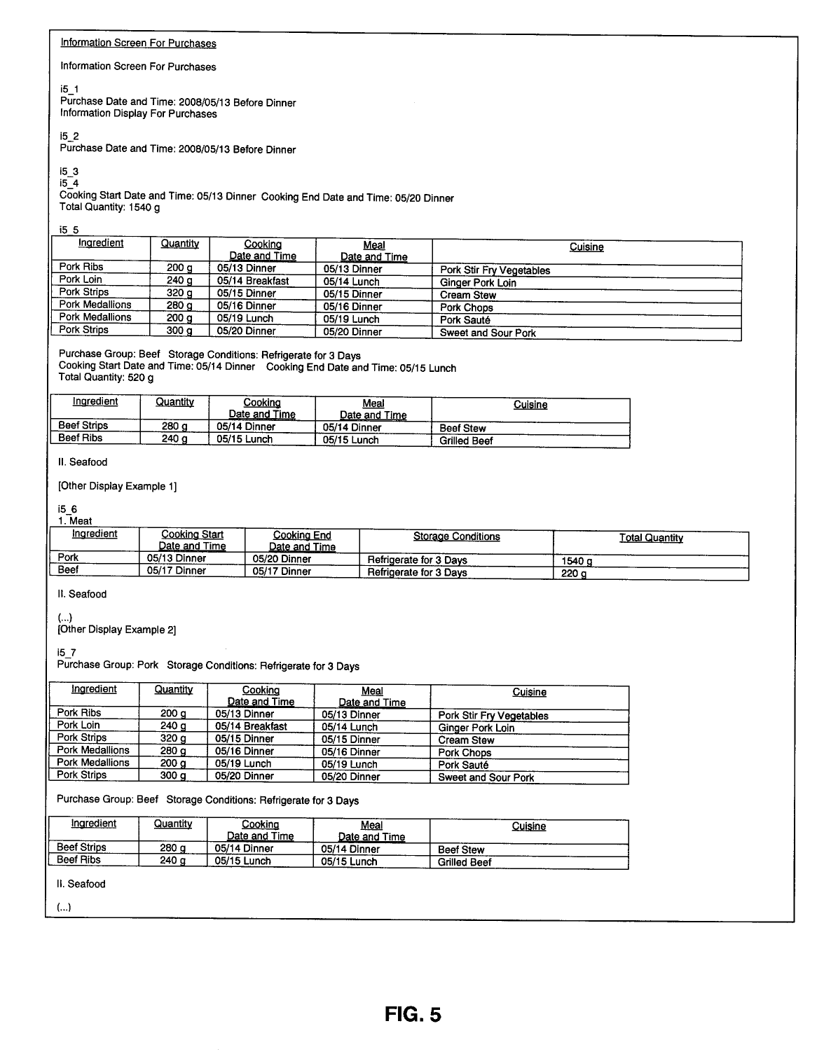

FIG. 5 is an example of a purchase information screen in the first operational example. Initially, the purchase information display section i5_2 is blank. Purchase dates and times ranging from one to seven days after the CPU date and time are linked to necessary ingredients in the menu-necessary ingredient TBL 1412 and stored in i5_1 in order to avoid duplication (in FIG. 4, the purchase dates and times are 5/13 before dinner, 5/17 before lunch, and 5/20 before dinner). The user selects a purchase date and time in i5_1 and presses the purchase information display button.

Then, in S3 (FIG. 3), the system of the present invention extracts the necessary ingredients matched with the purchase dates and times from the necessary ingredient information storing means, and the necessary ingredients are sorted by purchase group and purchase date and time, edited, and displayed in i5_2 (FIG. 5). While not essential, when sorting the information, the cooking start date and time indicating the earliest cooking date and time (smallest value cooking date and time) and the cooking end date and time indicating the latest cooking date and time (largest value cooking date and time) are also determined. In this embodiment, the necessary ingredients matching the purchase dates and times are extracted first. If also sorted by purchase group, similar results can be obtained by sorting by purchase group and purchase date and time. Sorting by purchase group and purchase date and time can be performed using purchase group IDs.

When the user references purchase information while purchasing (procuring) actual foods, the information is edited based on purchase groups and purchase dates and times to support (assist) in the purchase of actual foods with reference to necessary ingredients sorted by purchase group and purchase dates and times.

i5_4 (FIG. 5) within i5_2 (FIG. 5) includes aggregate information (referred to below as “purchase aggregate information” composed of cooking start dates and times, cooking end dates and times, and quantities (or number of items) determined when the necessary ingredients were sorted by purchase group and purchase dates and times. i5_5 (FIG. 5) includes detailed information on the necessary ingredients as a breakdown of the sorting process (referred to below as “purchase breakdown information”). In FIG. 5, the purchase aggregate information i5_4 (FIG. 5) and the purchase breakdown information i5_5 (FIG. 5) are combined to provide purchase information i5_3 (FIG. 5). However, purchase breakdown information i5_5 (FIG. 5) only or purchase aggregate information i5_4 (FIG. 5) only can be edited as purchase information i5_3 (FIG. 5) and display in i5_2 (FIG. 5). When the user references this purchase information during the purchase (procurement) of actual foods, the purchase information can be edited to achieve the purpose of assisting (guiding) the user in the purchase not of necessary ingredients but actual foods with respect to necessary ingredients sorted by purchase group and purchase date and time. In another example, the purchase aggregate information can be sorted by purchase group, purchase date and time, and quantity. The purchase breakdown information can also include ingredient names and quantities (referred to below as “cooking quantities”). The purchase breakdown information can include ingredient names only. The purchase breakdown information can be linked to the purchase aggregate information, but displayed on a separate screen.

i5_6 (FIG. 5) is an example in which purchase aggregate information i5_4 (FIG. 5) only is edited as purchase information i5_3 (FIG. 5) and displayed in i5_2 (FIG. 5). The essential information is the purchase group and quantity. The other information is not required. i5_7 (FIG. 5) is an example in which purchase breakdown information i5_5 (FIG. 5) only is edited as purchase information i5_3 (FIG. 5) and displayed in i5_2 (FIG. 5). Here, the essential information is the ingredient name and quantity. (Of course, it has to be sorted by purchase group and identified by purchase group and purchase date and time.) The other information is not required. When there are few ingredients belonging to a purchase group, the user is less likely to pay attention to specific foods in the purchase aggregate information. When there are a large number of ingredients belonging to a purchase group, the user is more likely to pay attention to specific foods in the purchase aggregate information. In other words, the purchase breakdown information is more important in the case of the latter.

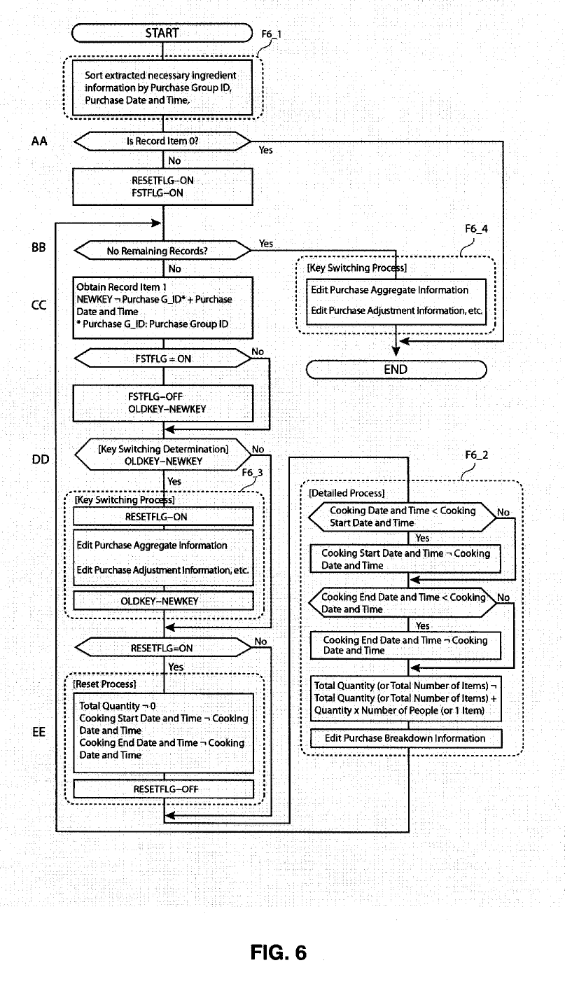

Sorting by purchase group and purchase date and time can be realized in the key switching process. The relational database function can also be used. FIG. 6 is an example of a flowchart used to perform the key switching process in S3 (FIG. 3).

The necessary ingredient information to be processed in F6_1 (FIG. 6) is sorted (organized) using the purchase group ID and purchase date and time as sort keys.

The steps in (a) through (c) are performed in the process F6_2 (FIG. 6).

(a) The cooking date and time are compared to the provisional cooking start date and time and cooking end date and time, and are updated when the cooking date and time have a smaller value (are earlier) than the cooking start date and time or when the cooking date and time have a larger value (are later) than the cooking end date and time. The provisional cooking start date and time and the provisional cooking end date and time when the key switching process is performed F6_3 (FIG. 6) and F6_4 (FIG. 6) are, respectively, the cooking date and time with the smallest (earliest) cooking date and time and the cooking date and time with the largest (latest) cooking date and time

(b) Editing of the purchase breakdown information.

(c) Addition of the necessary quantity (or item) for each necessary ingredient as the quantity (or number of items).

Here, a necessary quantity is calculated using “quantity×number of people”. Usually, the unit of measurement depends on the ingredient. Sometimes different units of measurement are used for the same ingredient. This can be systematized using a quantity based on grams (g). At the very least, the units of ingredients aggregated by purchase group and purchase date and time should be systematized. Here, the quantities used to calculate the cooking quantities are managed separately. Some of the units used in the cooking quantities include one tablespoon, one cut, and one item.

In the key switching process of F6_3 (FIG. 6) and F6_4 (FIG. 6) in which “purchase group ID and purchase date and time” is the processing key, the purchase aggregate information and purchase information are edited. The results of the editing are displayed as purchase information in i5_2 (FIG. 5). The display means can be a portable information terminal 4. In this case, for example, the results of the editing are sent to the portable information terminal 4 as email, and this is referenced using the mail software (mailer) in the portable information terminal 4. In this way, the purchase information can be referenced before leaving for the supermarket. In the screen example shown in FIG. 5, the sorting is done by ingredient category (meat and seafood). In this embodiment, the necessary ingredients matching the purchase date and time are extracted and sorted by purchase group. Similar results can be obtained when the necessary ingredients are sorted by purchase group and purchase date and time. Here, the purchase group ID can be used as a processing key for the key switching process.

When the purchase information is referenced by the user while purchasing actual food, it should guide the user in the purchase of actual food by purchase group and purchase date and time. Here, the information related to necessary ingredients is edited so that it can be identified by purchase group and purchase date and time.

For example, purchase information can be display using purchase date and time registration information (in which the purchase date and time registration information and the purchase information are displayed together on the same screen). For example, in FIG. 4, a new purchase reference date and time i4_4 is entered. Here, the purchase reference date and time are indicated by the user (or the CPU date and time are used). The background color of the necessary ingredients whose registered purchase date and time matches the reference date and time may be changed (display example: i4_5) or indicated with a certain mark. Here, the information related to the necessary ingredients can be edited so that it can be identified by purchase group and purchase date and time. In another example, i4_4 is set, and the background color is changed so that the user can identify the information by purchase date and time. Necessary ingredients whose registered purchase date and time match the reference purchase date and time (i.e., the background color is changed as shown in display example i4_5) are the only ones displayed. Other necessary ingredient information is not displayed. A screen example with this purchase information is similar to a second display example i5_7 in FIG. 5.

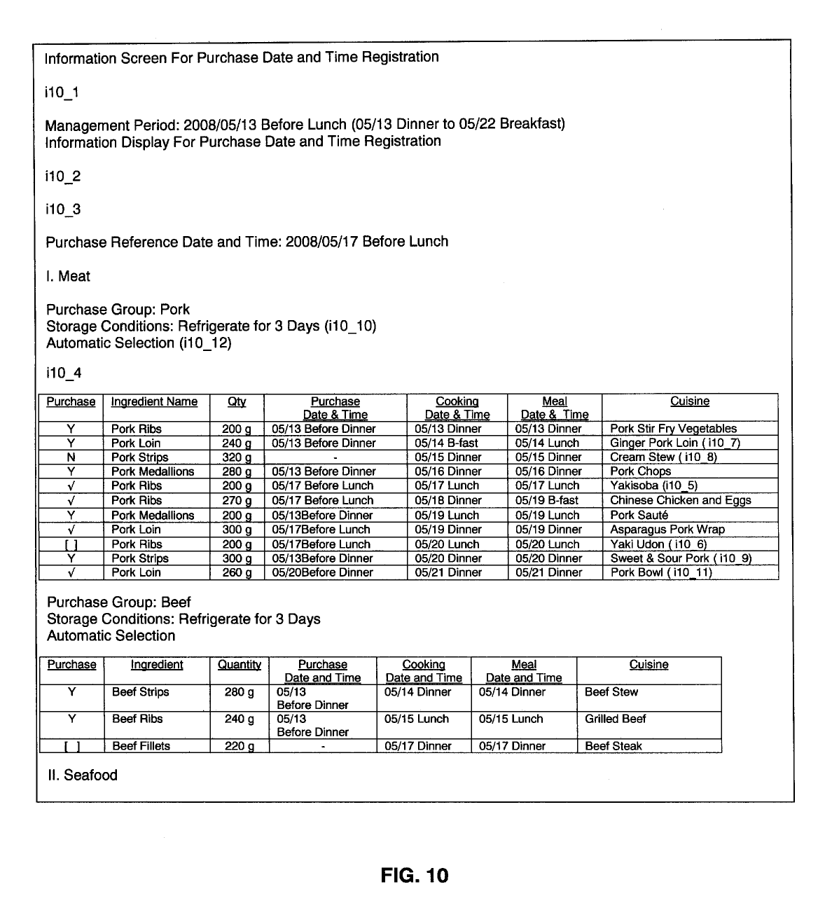

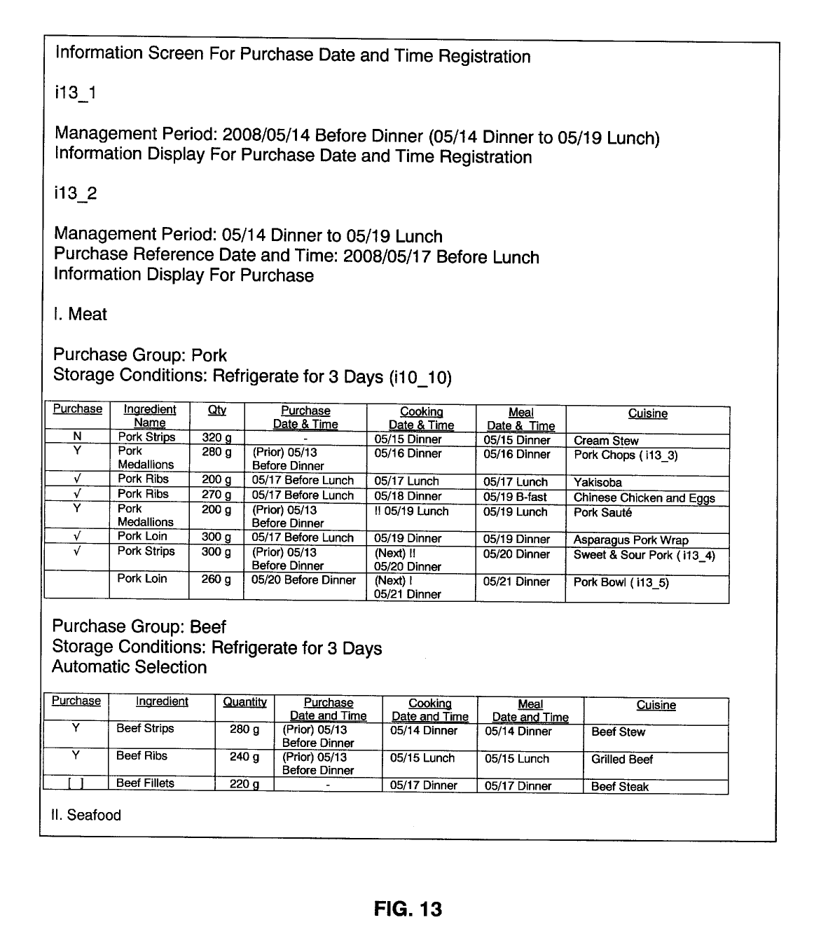

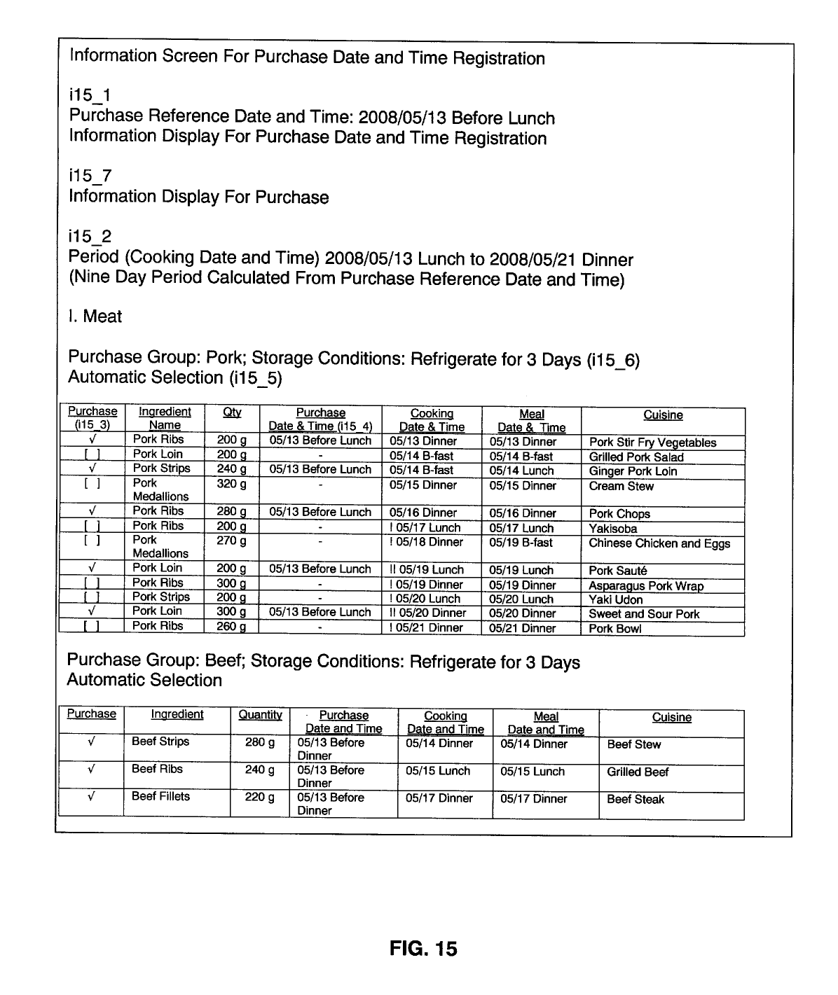

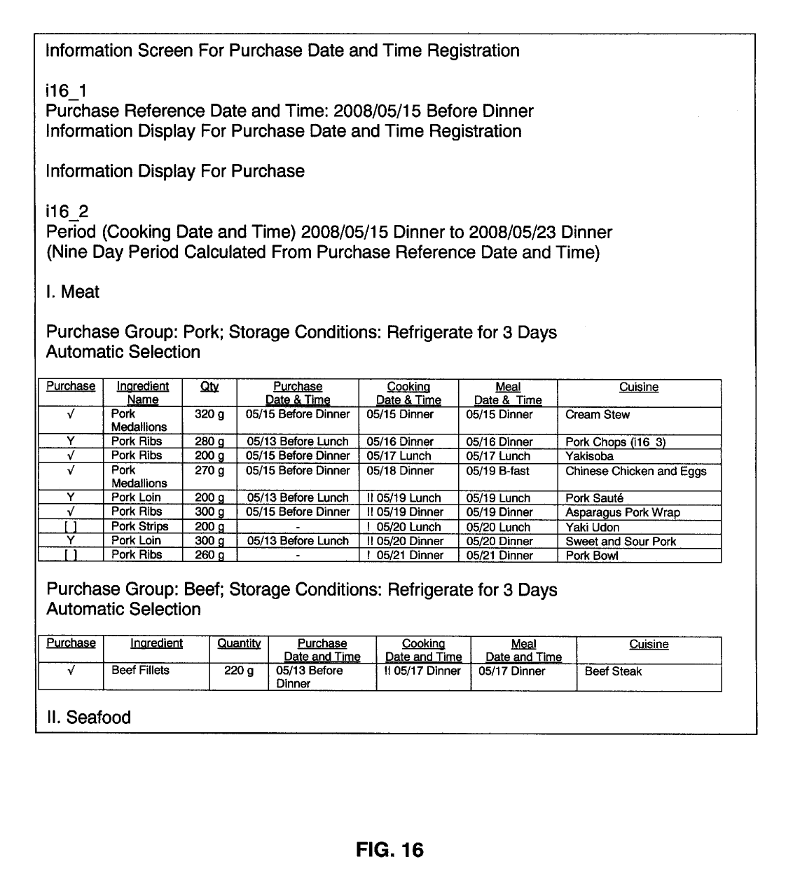

FIG. 10, FIG. 13, FIG. 15 and FIG. 16 are screen examples used in explanations provided below. These are easier to use than FIG. 4 because they have a column allowing the user to enter the purchase reference date and time on site (or use the CPU date and time as the purchase reference date and time). When necessary ingredients with different purchase dates and times are edited by purchase group, the background color can be changed to allow the user to (more easily) identify the necessary ingredients whose registered purchase date and time match the indicated purchase date and time (or CPU date and time). Here, the purchase information can be displayed using the purchase date and time registration information.

When purchase information is displayed using purchase date and time registration information, the function realized by the purchase information editing means S3 in FIG. 3 can be incorporated into the purchase date and time registration information editing means S1 to create a single means. Here, the algorithm shown in FIG. 6 is not required. The condition “change the background color to an identifiable color when the purchase date and time match” can be used.

When necessary ingredients are edited by information specifying the cuisine and purchase date and time registration information is linked to the necessary ingredients, or when the necessary ingredients are edited in similar fashion, the same effect can be obtained by changing to an identifiable color the background color of the necessary ingredients having a purchase group and purchase date and time matching the purchase group and purchase date and time selected by the user.

In all of these cases, necessary ingredient information is used to edit aggregate information, and the result is edited and displayed as purchase information in a section of the screen.

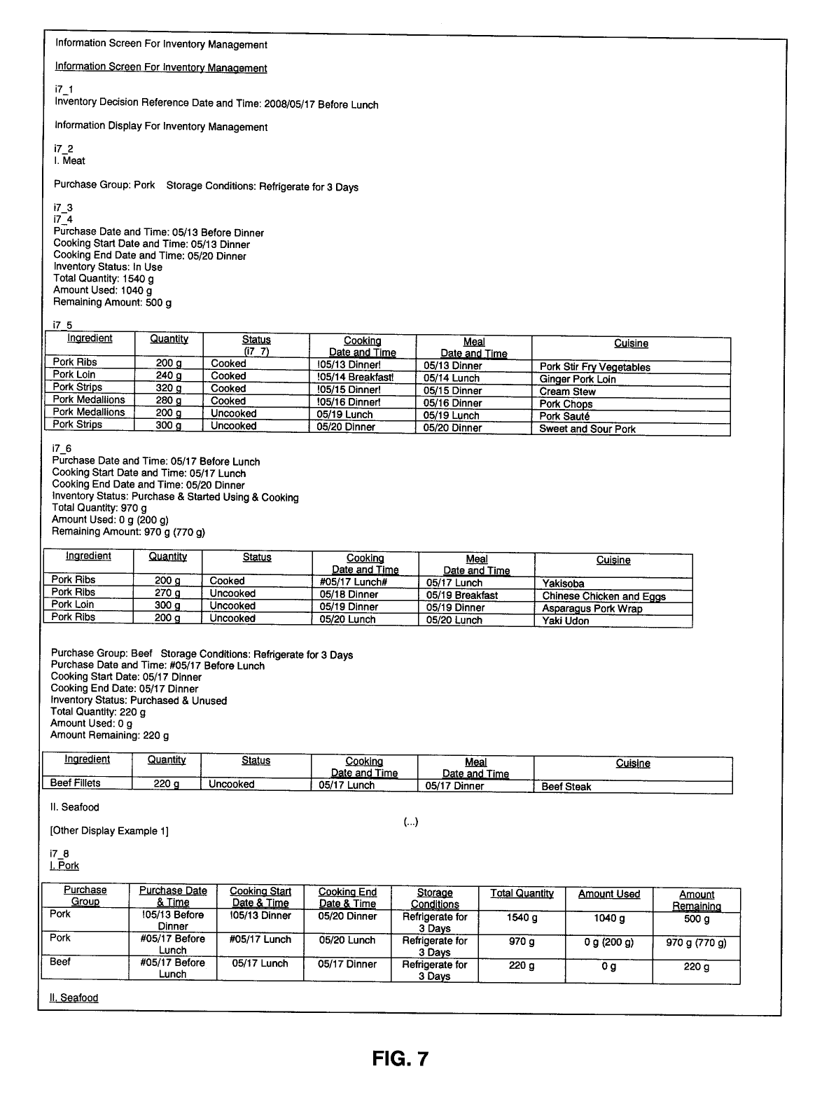

The display content of i5_6 in the first example of a purchase information screen in FIG. 5 includes the purchase date and time (i5_1 shown together with i5_6 in FIG. 5) and the cooking end date and time (i5_6 in FIG. 6), which are the display conditions for the inventory management information (i7_2 in FIG. 7) described below. When the purchase information matches the purchase date and time registration information as described earlier, it means the purchase information matches the inventory management information. In one example, the purchase information can be displayed using the inventory management information (the inventory management information and the purchase information can be displayed together on the same screen).

When inventory management information is used to display the purchase information in this manner (or vice versa), the function realized by the purchase information editing means S3 in FIG. 3 can be incorporated into the inventory management information editing means S4 (or vice versa) to create a single means.

### 3.1.5. Inventory Management Information Editing Means

The inventory management information editing means is a means allowing the user to edit inventory aggregate information, which is information aggregated by purchase group and purchase date and time so that inventory presence periods can be identified. An inventory presence period is usually the period from the purchase date and time to the cooking end date and time.

FIG. 7 is an example of an inventory management information screen in the first operational example. Initially, the inventory management information display unit i7_2 (FIG. 7) is blank. The inventory decision reference date and time, which is a date and time serving as a reference when the inventory status is checked, is loaded in i7_1 (FIG. 7). This date and time ranges from three days before to seven days after the CPU date and time (5/16 before dinner, 5/17 before breakfast, 5/17 before lunch, 5/17 before dinner, 5/18 before breakfast, etc.). The user selects an inventory decision reference date and time in i7_1 (FIG. 7), and presses the inventor management information display button.

Here, the inventory decision reference date and time are the date and time serving as a decision reference when the user checks the inventory status. For example, when the inventory status is to be checked prior to cooking lunch on 2008/05/17, “2008/05/17 before lunch” is set in i7_1 (FIG. 7). The CPU date and time can also be used.

Then, in S4 (FIG. 3), the system of the present invention extracts the necessary ingredient information from the necessary ingredient information storing means, sorts the necessary ingredient information by purchase group and purchase date and time as inventory management sort information, and displays the organized information in i7_2 (FIG. 7). During the sorting process, the cooking start date and time (the minimum value cooking date and time) is used as the initial cooking date and time, and the cooking end date and time (the maximum value cooking date and time) is used as the final cooking date and time.

i7_4 (FIG. 7) in i7_2 (FIG. 7) contains aggregate information (referred to as “inventory aggregate information” below) which is the cooking start date and time and the cooking end date and time determined by sorting necessary ingredient information by purchase group and purchase date and time. i7_5 (FIG. 7) is for detailed necessary ingredient information which is a breakdown from the sorting process (referred to below as “inventory management necessary ingredient breakdown information”). In FIG. 7, the inventory management sort information i7_3(FIG. 7) is a combination of inventory aggregate information i7_4 (FIG. 7) and inventory management necessary ingredient breakdown information i7_5 (FIG. 7). At a minimum, this includes the purchase date and time and the cooking end date and time. The inventory aggregate information i7_4 (FIG. 7), which is aggregated by purchase group and purchase date and time so that the user can identify the inventory presence period, which is the period from the purchase date and time to the cooking end date and time, is edited as inventory management sort information i7_3 (FIG. 7) and displayed in i7_2 (FIG. 7). This is because the minimum amount of information needed to manage an inventory is the purchase date and time and the cooking end date and time, which can be used to identify the inventory presence period. These two sets of information are included in the inventory aggregate information i7_4 (FIG. 7).

i7_8 (FIG. 7) is an example in which the inventory aggregate information i7_4 (FIG. 7) alone is edited as inventory management sort information i7_3 (FIG. 7) and displayed in i7_2 (FIG. 7). The inventory management necessary ingredient breakdown information i7_5 (FIG. 7) is linked to inventory aggregate information i74 (FIG. 7) or inventory aggregate information i7_8 (FIG. 7) and displayed on a separate screen.

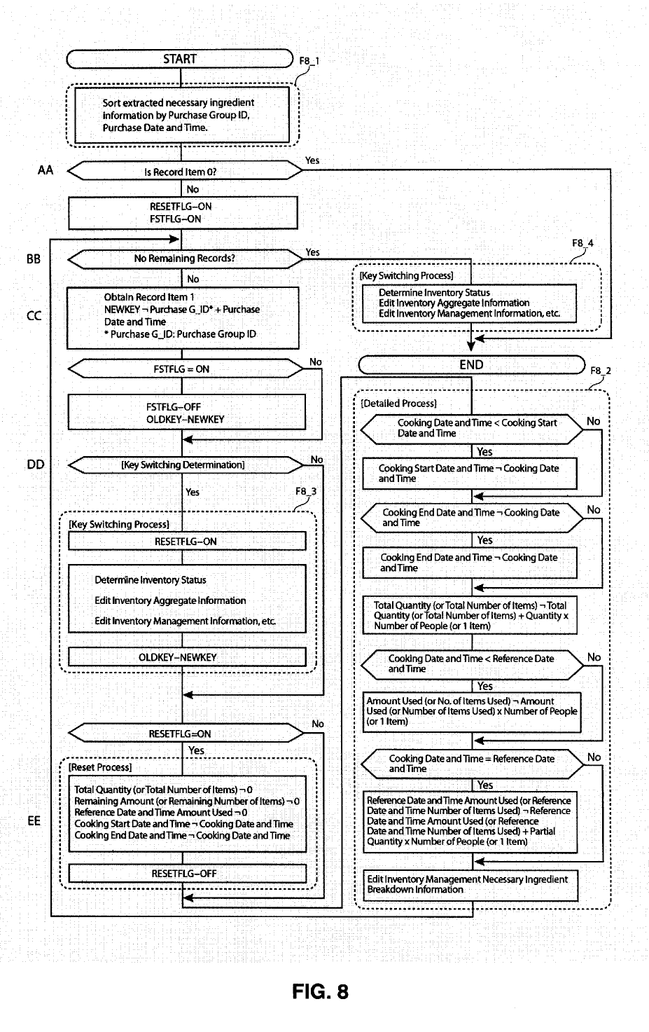

Sorting by purchase group and purchase date and time can be realized using the key switching process. A relational database function can also be used. FIG. 8 is an example of a flowchart used by the key switching process in S4 (FIG. 3).
An ingredient is in the inventory for use at the inventory reference date and time when the inventory management sort information (or inventory aggregate information) satisfies the condition “cooking start date and time≦inventory decision reference date and time≦cooking end date and time”.
An ingredient is starting to be used (use start) at the inventory reference date and time when the inventory management sort information (or inventory aggregate information) satisfies the condition “cooking start date and time=inventory decision reference date and time”.
An ingredient is almost finished being used (use end) at the inventory reference date and time when the inventory management sort information (or inventory aggregate information) satisfies the condition “cooking end date and time=inventory decision reference date and time”.

The results from the decision-making processes in (a) through (c) can be combined in other ways. For example, “inventory reference date and time<purchase date and time” means an ingredient is not in the inventory because the inventory decision reference date is prior to purchase. The necessary inventory management sort information (or inventory aggregate information) can be displayed rather than not displayed, or the background color (or text color) can be changed based on the decision-making results so that they can be recognized. This inventory management information is displayed in i7_2 (FIG. 7). In the inventory management information screen shown in FIG. 7, the inventory management sort information for the inventory presence period is displayed in i7_2 (FIG. 7) at a inventory decision reference date and time satisfying the condition “purchase date and time≦inventory management reference date and time”.

The flowchart in FIG. 8 does not have to be used. For example, necessary ingredient information can be extracted using a specific purchase group and purchase date and time, and the inventory aggregate information can be edited by purchase group and purchase date and time.

The inventory management information acquiring means obtains the final cooking date and time from among the cooking dates and times linked to the necessary ingredient information linked, in turn, to the same purchase group and purchase date and time by the inventory management information editing means, and this serves as the cooking end date and time, which is the date and time by which the inventory will run out. The inventory management information editing means also edits the inventory aggregate information, which is the information aggregated by purchase group and purchase date and time by the inventory management inventory acquiring means, to allow the user to identify the inventory

In F8_3 (FIG. 8) and F8_4 (FIG. 8), in which the key switching process is performed using the purchase group ID and the purchase date and time as the processing keys, the inventory status (inventory presence or absence, etc.) is determined, the inventory aggregate information is edited, and the inventory management sort information is edited, among other steps. The editing results are displayed in i7_2 (FIG. 7). A portable information terminal 4 (FIG. 1) can be used as the display means. In this situation, for example, the editing results are sent as email to the portable information terminal 4, and are referenced using the mail software in the portable information terminal 4.

In the screen example shown in FIG. 4, the sorting is performed by ingredient type.

Here, the inventory status (inventory presence or absence, etc.) decisions performed in the key switching process F8_3 (FIG. 8) and F8_4 (FIG. 8) are performed on the inventory management sort information (or inventory aggregate information) using the inventory decision reference date and time indicated in i7_1 (FIG. 7) and at least one of the decision-making steps in (a) through (c) below.

(a) The inventory decision reference date and time are compared to the purchase date and time to make before and after purchase decisions.

(b) The inventory decision reference date and time are compared to the cooking start date and time to make decisions before and after the start of use.

(c) The inventory decision reference date and time are compared to the cooking end date and time to make decisions before and after the end of use.

The results from the decision-making processes in (a) through (c) can be used to determine the inventory status in the following situations.
An ingredient is in the inventory (present in the inventory and within the inventory presence period) at the inventory reference date and time when the inventory management sort information (or inventory aggregate information) satisfies the condition “purchase date and time≦inventory decision reference date and time≦cooking end date and time”.
An ingredient is in the inventory for use at the inventory reference date and time when the inventory management sort information (or inventory aggregate information) satisfies the condition “cooking start date and time≦inventory decision reference date and time≦cooking end date and time”.
An ingredient is starting to be used (use start) at the inventory reference date and time when the inventory management sort information (or inventory aggregate information) satisfies the condition “cooking start date and time=inventory decision reference date and time”.
An ingredient is almost finished being used (use end) at the inventory reference date and time when the inventory management sort information (or inventory aggregate information) satisfies the condition “cooking end date and time=inventory decision reference date and time”.

The results from the decision-making processes in (a) through (c) can be combined in other ways. For example, “inventory reference date and time<purchase date and time” means an ingredient is not in the inventory because the inventory decision reference date is prior to purchase. The necessary inventory management sort information (or inventory aggregate information) can be displayed rather than not displayed, or the background color (or text color) can be changed based on the decision-making results so that they can be recognized. This inventory management information is displayed in i7_2 (FIG. 7). In the inventory management information screen shown in FIG. 7, the inventory management sort information for the inventory presence period is displayed in i7_2 (FIG. 7) at a inventory decision reference date and time satisfying the condition “purchase date and time≦inventory management reference date and time”.

The flowchart in FIG. 8 does not have to be used. For example, necessary ingredient information can be extracted using a specific purchase group and purchase date and time, and the inventory aggregate information can be edited by purchase group and purchase date and time.

The inventory management information acquiring means obtains the final cooking date and time from among the cooking dates and times linked to the necessary ingredient information linked, in turn, to the same purchase group and purchase date and time by the inventory management information editing means, and this serves as the cooking end date and time, which is the date and time by which the inventory will run out. The inventory management information editing means also edits the inventory aggregate information, which is the information aggregated by purchase group and purchase date and time by the inventory management inventory acquiring means, to allow the user to identify the inventory presence period, which is the period from the purchase date and time to the cooking end date and time, including at the very least the purchase date and time and the cooking final date and time.

### 3.1.6. Management Method for Menu Ingredients Managed by the System of the Present Invention

Managing the inventory means managing activities from the purchase to the cooking of actual foods so that the user does not run out of ingredients. When necessary ingredient information linked to cooking dates and times is stored as menu planning information, and when the user links purchase dates and times to necessary ingredient information and stores the linked information, the necessary ingredients can be managed from the purchase date and time to the cooking date and time.

The following are the unique characteristics of actual foods, which are managed by the system of the present invention.
Unlike materials such as industrial parts, ingredients (actual foods) can be substituted.
Actual foods have to be managed by purchase date and time because the quality assurance period (expiration date) is usually not very long.

From this perspective, purchase group and purchase date and time are treated as purchase and inventory management units, and the period from the purchase date and time to the cooking date and time are used as the management method for ingredients.

### 3.1.7. Display Content of Inventory Management Information Screen

In the inventory management information screen (FIG. 7), i7_4 (FIG. 7) or i7_6 (FIG. 7) or i7_8 (FIG. 7) contains inventory aggregate information. Purchase dates and times, cooking start dates and times, cooking end dates and times, inventory status, total quantities, amounts used, and amounts remaining sorted beforehand by purchase group and purchase date and time are displayed. The remaining amounts (or remaining items) are calculated in F8_2 (FIG. 8) from the total quantity (or total number of items) sorted by purchase group and purchase date and time as well as from the amount used (or number of items used) based on the equation “remaining amount (or remaining number of items)=total quantity (or total number of items)−amount used (or number of items used)”.

i7_6 (FIG. 7) is a display example for inventory management sort information in which it has been determined that “cooking will occur during the inventory management reference date and time”. (This is the “cooking” portion of “status: purchase & use begins & cooking”.) Here, “cooking will occur during the inventory decision reference date and time” means some of the necessary ingredient information in detailed process F8_2 (FIG. 8) satisfies the condition “cooking date and time=inventory management reference date and time”. In other words, the amount used on the inventory management reference date and time mentioned above is not zero.

The amount used after cooking is the portion of the amount used in i7_6 (FIG. 7) which appears in parentheses. The amount used on the inventory decision reference date and time (or the number of items used on the inventory decision reference date and time) is used to perform a calculation using the equation “amount used after cooking (or number of items used after cooking)=amount used (or number of items used)+amount used on inventory decision reference date and time (or number of items used on inventory decision reference date and time)”.

In the amount remaining in i7_6 (FIG. 7), the portion in parentheses is the amount remaining after cooking. The amount used after cooking (or the number of items used after cooking) is used to perform a calculation using the equation “amount remaining after cooking (or the number of items remaining after cooking)=total quantity (or total number of items)−amount used after cooking (or number of items used after cooking).”

i7_5 (FIG. 7) is the inventory management necessary ingredient breakdown information. The necessary ingredients are displayed as objects of aggregation. Here, i7_7 (FIG. 7) is the result of a comparison of the inventory decision reference date and time to the items in “purchase date and time, cooking date and time” for each necessary ingredient. The following are specific examples of the comparison process.
“Before Purchase” IF “Reference Date and Time<Purchase Date and Time”
“Uncooked” IF “Purchase Date and Time<Reference Date and Time<Cooking Date and Time”
“Cooking” IF “Purchase Date and Time≦Reference Date and Time=Cooking Date and Time”
“Cooked” IF “Purchase Date and Time≦Cooking Date and Time<Reference Date and Time”

Other examples include the following.
“Purchase” IF “Reference Date and Time=Purchase Date and Time”
“Purchased” IF “Reference Date and Time≧Purchase Date and Time”

These and other decision processes can be used.

Also, in FIG. 7, when the purchase date and time, cooking start date and time, and cooking end date and time in the inventory aggregate information, as well as the cooking date and time and the meal date and time in the inventory management necessary ingredient breakdown information are compared to the inventory decision reference date and time, and there is a match, a pound sign (#) is attached to the header. When there is no match (the dates are earlier than the inventory decision reference date and time), an exclamation point (!) is attached to the header.

### 3.1.8. Application Example

Also, when actual food products (referred to below simply as “food products”) are ordered by the user using an information device such as the internet, and the system of the present invention stores the order information, or when information on actual food purchases is entered by the user and the system of the present invention stores the information on actual food purchases, the order information or information on actual food purchases is linked to a purchase group ID and purchase date and time, and then stored. It is also linked to the inventory management sort information by purchase group ID and purchase date and time and edited. Because the inventory basically should run out after the cooking end date and time, there is no need to enter the fact that the inventory has run out. It can be managed from entry of order information or actual food purchase information to the cooking end date and time.

### 3.2. Operational Example 2

In the second operational example of the present invention, the management period is established for one week (e.g., from lunch on Saturday until breakfast on the following Saturday) based on the management period purchasing style described above. Before lunch on the initial Saturday in the management period for the necessary ingredients used in cooking, (actual foods corresponding to) the necessary ingredients expected to be used (consumed) by the expiration deadline (or freshness deadline) are purchased (bought, procured) in bulk. This example assists a user with a purchasing style in which the remaining necessary ingredients (e.g., necessary ingredients not used (or consumed) by the expiration date) are purchased (bought, procured) at the supermarket at a later date.

### 3.2.1. Management Period Storing Means

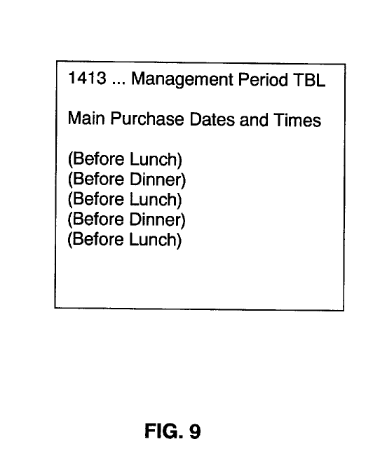

The management period is the period referenced when the user purchases ingredients and performs inventory management. FIG. 9 is an example of data in the management period TBL 1413. The data in the main purchase dates and times is a combination of dates and times and codes. As in “2.1.3 Management Period TBL 1413”, the codes are 0 for before breakfast, 1 for before lunch, and 2 for before dinner. In this embodiment, the two consecutive main purchase dates and times are main purchase date and time 1 for the earlier main purchase date and time, and main purchase date and time 2 for the later main purchase date and time. The period extending from after main purchase date and time 1 to before main purchase date and time 2 is the management period. In other words, main purchase date and time 1≦management period≦main purchase date and time 2.

Registration of the main purchase date and time in the management period TBL 1413 is performed using a function for registering the main purchase date and time (the main purchase date and time registration means). More specifically, the main purchase date and time are received from the input device 12 and stored in the management period TBL 1413 based on the received information.

Another method for storing the management period can be a rule such as “the main purchase date and time are before dinner every Saturday”. Here, the information related to the management period can be stored in a processing program.

The management period storing means corresponds to the management period storing means in the claims. Because the management period storing means is a means unique to the second operational example, it is omitted from FIG. 3.

### 3.2.2. Purchase Date and Time Registration Information Editing Means

FIG. 10 is an example of a purchase date and time registration information screen in the second operational example. Initially, the purchase date and time registration information display area i10_2 (FIG. 10) is blank, and information is loaded into i10_1 (FIG. 10) based on the management period TBL 1413. In i10_1 (FIG. 10), the user selects the management period (main purchase date and time) and the purchase date and time registration information display button is pressed.

Next, in S1 (FIG. 2), the system of the present invention acquires information specifying the management period based on the information selected in i10_1 (FIG. 10). For example, main purchase date and time 1, or the main purchase date and time in the selected management period, and main purchase date and time 2, or the subsequent main purchase date and time, are received. Here, the management period is the management period satisfying the condition “main purchase date and time 1≦management period<main purchase date and time 2”. At this time, the main purchase date and time 1 can be received, and the main purchase date and time 2 can be derived based on the management period TBL 1413. Information specifying the management period can also be obtained. Management periods derived from the CPU date and time can also be used. This can be, for example, a management period including the CPU date and time, as well as the next management period.

Next, the system of the present invention based on the necessary ingredient information storing means, extracts necessary ingredient information satisfying the condition “main purchase date and time 1≦cooking date and time<main purchase date and time 2”. In other words, it extracts information satisfying the condition “the cooking date and time are within the management period”. (It can also extract information satisfying the condition “the purchase date and time are not registered, but the cooking date and time are within the management period” or “the purchase date and time are registered and both the purchase date and time and the cooking date and time are within the management period”.)

The purchase reference date and time i10_3 (FIG. 10) can be a value indicated by the user, the main purchase date and time 1, a date and time near the CPU date and time, or a date and time in the management period beginning with the main purchase date and time. For each necessary ingredient, it is determined whether or not the condition “the cooking date and time are within the management period, and the purchase reference date and time are before the cooking date and time” has been satisfied. (In the second operational example, in addition to this condition, it can also be determined whether or not necessary ingredients with the registered purchase date and time use the pattern in (a) described below, and whether or not the necessary ingredients with the registered purchase date and time satisfy the condition “the registered purchase date and time satisfy (purchase date and time≧purchase reference date and time)” in order to keep them from being easily overwritten.) When these are satisfied, the purchase date and time registration information is edited so that it can be identified (differentiated) as separate necessary ingredient information with a registerable purchase date and time (referred to below as “purchase date and time registerable necessary ingredient information”) in order to help user follow a management period purchasing style. This is displayed in i10_2 (FIG. 10). In this way, the user can identify the purchase date and time registerable necessary ingredient information via the purchase date and time registration information screen (FIG. 10). Here, the purchase date and time registerable necessary ingredient information used to assist with the management period purchasing style is necessary ingredient information that can register the purchase reference date and time as the purchase date and time (or update it if the purchase date and time have already been registered) to assist with the management period purchasing style. In the purchase date and time registration information screen (FIG. 10), there is a checkbox in i10_4 for purchase date and time registerable necessary ingredient information. Because the checkbox is not displayed for other necessary ingredient information, the purchase reference date and time cannot be registered as the purchase date and time for them. By editing information so that only purchase date and time registerable necessary ingredient information can be registered using the purchase reference date and time, the user can only register purchase date and time registerable necessary ingredient information using the purchase reference date and time. In this way, it is easily identifiable even when the text color or background color is changed.

Here, the purchase reference date and time are the date and time for referencing a purchase (shopping). In the second operational example, it is any date and time within the management period for referencing a purchase (shopping) (i.e., a purchase reference date and time within the management period). For example, in the purchase date and time registration information screen (FIG. 10), when a necessary ingredient is selected for purchase immediately before preparation of lunch on 2008/05/17, 2008 May 17 before lunch is indicated in i10_3 (FIG. 10). A date and time in the management period is loaded in the purchase reference date and time i10_3 (FIG. 10). In other words, the selectable purchase reference dates and times are dates and times within the management period selected in i10_1 (FIG. 10).

The necessary ingredient information can essentially be displayed freely in the purchase date and time registration information screen. However, the necessary ingredient information should satisfy the extraction condition “the cooking date and time are within the management period” (or at least one of the following: “a purchase date and time have not been registered, but the cooking date and time are within the management period”, or “the purchase date and time have been registered, and both the purchase date and time and the cooking date and time are within the management period.”) This makes sure it is only purchase date and time registerable necessary ingredient information. Because only purchase date and time registerable necessary ingredient information is displayed, no contrivances such as the addition of marks or changes in background color are necessary to identify (differentiate) purchase date and time registerable necessary ingredient information. Of course, other necessary ingredient information can be displayed. However, the purchase date and time registerable necessary ingredient information should be identified (differentiated).

In order to prevent easy overwrite of necessary ingredient information with a registered purchase date and time, the condition “the cooking date and time are within the management period and the purchase reference date and time are before the cooking date and time” has to be satisfied, and necessary ingredient information with a registered purchase date and time also have to satisfy one of the following conditions.

(a) The registered purchase date and time satisfy “purchase date and time Z purchase reference date and time”.

(b) The registered purchase date and time satisfy “purchase date and time=purchase reference date and time”.

When this is satisfied, the registered purchase date and time can be overwritten by the purchase reference date and time. In other words, it is purchase date and time registerable necessary ingredient information. Either (a) or (b) can be used, depending on which method is easier. Alternately, when “purchase date and time>purchase reference date and time” in pattern (a), the purchase date and time can be overwritten with the purchase reference date and time. It can be prohibited in the case of pattern (b).

In the second operational example, pattern (a) is used on necessary ingredient information with a registered purchase date and time to prevent easy overwrites. When, in the case of each necessary ingredient extracted from the necessary ingredient information storing means, “the purchase date and time have been registered, and purchase date and time<purchase reference date and time”, it is determined in S1 (FIG. 3) that the ingredient has been purchased. A check mark is added in i10_4 (FIG. 10). A display example is shown in i10_7 (FIG. 10). Necessary ingredient information with a check mark is not purchase date and time registerable necessary ingredient information. The same process is performed in the third operational example.

When each necessary ingredient extracted from the necessary ingredient information storing means has “no purchase date and time, or cooking date and time<purchase reference date and time”, it is determined that a purchase has not been made. An “N” mark is added in i10_4 (FIG. 10). A display example is i10_8 (FIG. 10). Necessary ingredient information with an “N” mark is not necessary ingredient information with a registerable purchase date and time.

The system of the present invention stores quality assurance period information linked to necessary ingredient information such as storing quality assurance period information in the purchase group TBL 1415, etc. (A display example of quality assurance period information is shown in i10_10 (FIG. 10).) In S1 (FIG. 3), a quality assurance period warning is generated for each necessary ingredient extracted from the necessary ingredient information storing means when “there is no purchase date and time registered, and “cooking date and time>purchase reference date and time+quality assurance period”. When the purchase reference date and time are registered as the purchase date, an exclamation point (I) is added to the cooking date and time in order to indicate that it was not consumed within the quality assurance period. i10_11 (FIG. 10) is a display example. The same process can be performed in the third operational example.

In the system of the present invention, quality assurance period information linked to necessary ingredient information is stored such as storing quality assurance period information in the purchase group TBL 1415, etc. In S1 (FIG. 3), “quality assurance period over” is generated for each necessary ingredient extracted from the necessary ingredient information storing means when “there is a purchase date and time registered, and “cooking date and time>purchase date and time+quality assurance period”. Double exclamation points (!!) are added to the cooking date and time in order to indicate that it was not consumed within the quality assurance period when purchased according to the registered purchase date and time. i10_9 (FIG. 10) is a display example. i10_10 is another display example. The same process can be performed in the third operational example.

When the purchase reference date and time are updated in the purchase reference date and time i10_3, etc., the items affected by the purchase date and time registration information are edited again and displayed in i10_2.

### 3.2.3. Purchase Date and Time Registration Means

Next, in S2 (FIG. 3) of the system of the present invention, the user uses the input means 12 to input information specifying purchase date and time registerable necessary ingredient information for purchase on the purchase reference date and time within the purchase date and time registerable necessary ingredient information identifiable on the purchase date and time registration information screen (FIG. 10) by the checkboxes. In i10_4 (FIG. 10) of this embodiment, it is selected (inputted) by checking the checkbox of the necessary ingredient to be purchased on the purchase reference date and time indicated by i10_3. Basically by allowing the purchase date and time to be registered only for purchase date and time registerable necessary ingredient information, the purchase reference date and time can be registered by the user as the purchase date and time for purchase date and time registerable necessary ingredient information. Next, the purchase reference date and time are linked to the purchase date and time registerable necessary ingredient information based on the inputted information, and the linked information is stored. As mentioned above, a date and time outside of the management period cannot be selected in the purchase reference date and time i10_3. Usually, the purchase reference date and time are a purchase date and time satisfying the condition “within the management period and before the cooking date and time” or “main purchase date and time 1≦purchase date and time≦cooking date and time<main purchase date and time 2”. This is linked to the selected purchase date and time registerable necessary ingredient information, and the linked information is stored. When the data is stored in a server 3, the validity of the values should also be checked by the server 3.

The registered purchase date and time are displayed in the section corresponding to i10_5 (FIG. 10). When unchecked, a NULL value is stored in the purchase date and time attributes linked to the corresponding necessary ingredient information in menu-necessary ingredient TBL 1412. At the same time, a minus (−) sign is added to the section corresponding to i10_5 (FIG. 10).

Simply by selecting the purchase date and time registerable necessary ingredient information for purchase on the purchase reference date and time indicated in i10_3 (FIG. 10), a purchase date and time satisfying the necessary conditions can be registered. In this way, an effective purchase date and time can be registered. When the purchase date and time registration information screen (FIG. 4) in the first operational example is used, the user has to register a date and time while being mindful of which necessary ingredients are to be purchased. In the second operational example, by contrast, the user does not have to think about which necessary ingredients are to be purchased at the purchase reference date and time. This simplifies the decision-making process for the user.

In the purchase date and time registration method, information specifying a necessary ingredient and the purchase date and time does not have to be received. Information able to specify the purchase date and time corresponding to each necessary ingredient can be used. The system of the present invention can also use pre-stored information and algorithms to specify the purchase date and time corresponding to each necessary ingredient. For example, an automatic selection mechanism can be realized using an algorithm as explained below.

The quality assurance period is stored in the purchase group TBL 1414 or the menu-necessary ingredient TBL 1412, so the quality assurance period linked to the necessary ingredients is stored. i10_10 (FIG. 10) shows the quality assurance period stored in the system of the present invention. When the user selects the purchase reference date and time in i103 (FIG. 10) and presses the automatic selection button i10_12 (FIG. 10), the system of the present invention links it to necessary ingredient information satisfying the condition “purchase date and time not registered, cooking date and time within management period, and (purchase reference date and time≦cooking date and time≦purchase reference date and time+quality assurance period)”. The purchase reference date and time are then stored as the purchase date and time, and the purchase date and time are displayed in the section corresponding to i10_5 (FIG. 10). When the automatic selection button i15_5 (FIG. 15) is pressed under conditions other than “purchase reference date and time≦cooking date and time≦purchase reference date and time+quality assurance period”, the purchase group ID can be received, and the condition “purchase group ID matches” added.

### 3.2.4. Purchase Information Editing Means

When the user pushes the purchase information display button i10_13 (FIG. 10), the purchase reference date and time indicated in i10_3 (FIG. 10) are set as the purchase date and time, and purchase information is acquired in the same manner as i5_2 in the purchase information screen (FIG. 5). The details of this process are similar to those in “3.1.4 Purchase Information Editing Means”. It is also similar in that the purchase date and time registration information and the purchase information (or the inventory management information and the purchase information) are displayed on the same screen. (The purchase information is displayed using the purchase date and time registration information (or the inventory management information)).

### 3.2.5. Inventory Management Information Editing Means

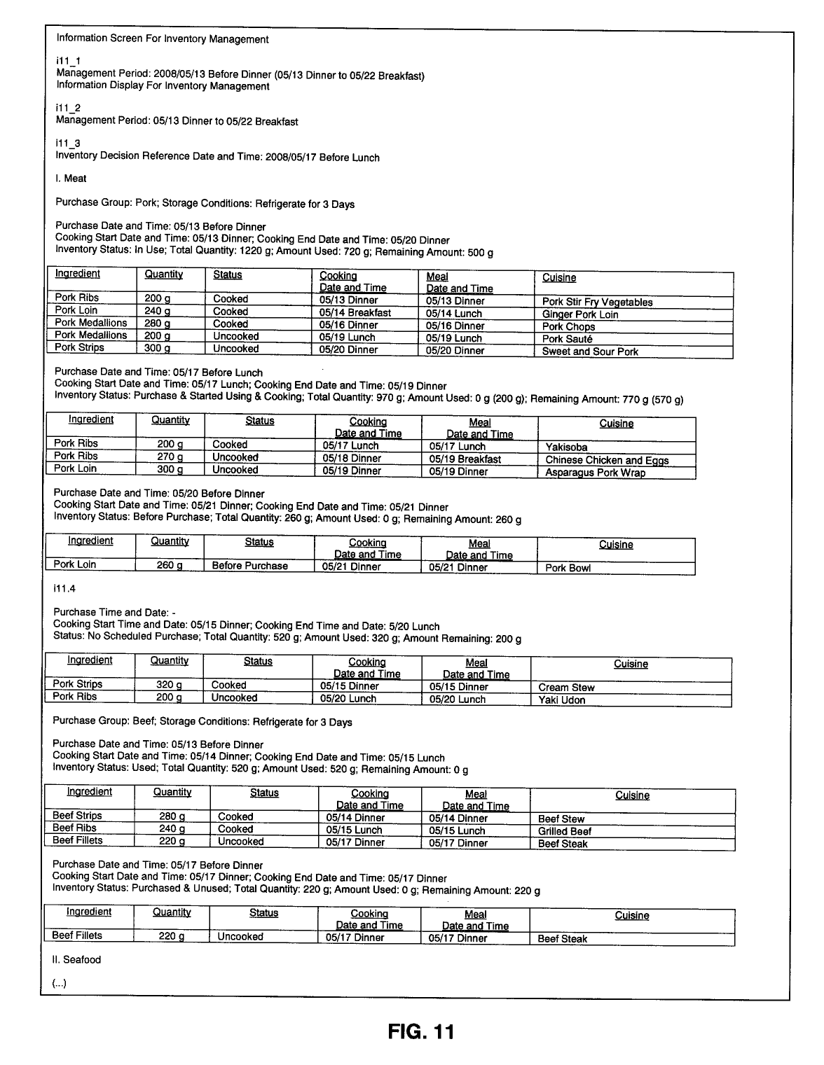

FIG. 11 is an example of an inventory management information screen in the second operational example. Initially, the inventory management information display section i11_2 (FIG. 11) is blank, and information is loaded in i11_1 (FIG. 11) based on the management period TBL 1413. The user selects a management period (main purchase date and time) for i11_1 (FIG. 11) in the inventory management information screen (FIG. 11), and presses the inventory management information display button.

Then, in S4 (FIG. 3), the system of the present invention obtains information specifying the management period based on the selected management period (main purchase date and time). For example, main purchase date and time 1, which is the selected main purchase date and time, and main purchase date and time 2, which is the next main purchase date and time, are received. At this time, the management period is a management period that satisfies the condition “main purchase date and time 1≦management period≦main purchase date and time 2”. Alternatively, main purchase date and time 1 can be received alone, and main purchase date and time 2 can be determined based on the management period TBL 1413. Information specifying the management period can also be received. In addition, a management period derived from the CPU date and time can be used. An example can be a management period including the CPU date and time, as well as the next management period.

### 3.2.5.1. When the Management Period Cannot Be Changed

There are situations in which the management period used to determine the purchase date and time registerable necessary ingredient information cannot be changed after a purchase date and time have been registered for the purchase date and time registerable necessary ingredient information. These situations include those in which a main purchase date and time change would shorten the management period, such as when main purchase date and time 1 is moved back and main purchase date and time 2 is moved forward. Here, in S4 (FIG. 3), the system of the present invention sorts the inventory management sort information by purchase group and purchase date and time for necessary ingredient information in which a purchase date and time have been registered based on the necessary ingredient information storing means. The cooking end date and time, or the cooking date and time with the maximum value (latest value), is determined for the inventory management sort information, and it is determined whether or not the condition “main purchase date and time 1≦purchase date and time≦cooking end date and time<main purchase date and time 2” has been satisfied. In other words, it is determined whether or not all times in the inventory presence period, which is the period from the purchase date and time to the cooking end date and time, are within the management period. When this condition has been satisfied, the inventory management information is edited so that the inventory management sort information (the inventory management sort information used to support the management period purchasing style) can be identified (differentiated) from inventory management sort information that does not satisfy the condition. This is displayed in i11_2 (FIG. 11). Here, as mentioned earlier, “main purchase date and time 1<main purchase date and time 2” and “purchase date and time≦cooking date and time” are both true.

The inventory management sort information can be prepared beforehand and stored in a database or file.

At this time, the inventory decision reference date and time i11_3 (FIG. 11) can be a value indicated by the user, the main purchase date and time 1, a date and time near the CPU date and time, or the final date and time in the management period beginning with the main purchase date and time 1.

Here, the inventory decision reference date and time are the reference date and time from when the user checked the inventory status. For example, “2008/05/17 before lunch” is indicated in i11_3 (FIG. 11) of the inventory management information screen (FIG. 11) when the inventory status is to be checked immediately before lunch on 2008/05/17.

At this time, the inventory management sort information can include inventory aggregate information used to support the management period purchasing style. This information (referred to below simply as the “inventory aggregate information”) is aggregated by purchase group and purchase date and time so that the user can check the management presence period, which is the period from the purchase date and time to the cooking end date and time.

When the purchase date and time can be registered for just the purchase date and time registerable necessary ingredient information in S2 (FIG. 3), the stored purchase date and time always satisfies the condition “main purchase date and time 1≦purchase date and time≦main purchase date and time 2”. When necessary ingredient information with a registered purchase date and time are sorted by purchase group and purchase date and time as inventory management sort information, the necessary ingredient information with a registered purchase date and time are extracted only if the condition “main purchase date and time 1≦purchase date and time≦cooking date and time<main purchase date and time 2” is satisfied (i.e., if the condition “both the purchase date and time and the cooking date and time are within the management period”). When this extracted necessary ingredient information is sorted by purchase group and purchase date and time, the amount of processing can be reduced, and the processing burden can be lightened.

### 3.2.5.2. When the Management Period May Be Changed (Even When Not Changed)

There are situations in which the management period used to determine the purchase date and time registerable necessary ingredient information may be changed after a purchase date and time have been registered for the purchase date and time registerable necessary ingredient information. These situations include those in which a main purchase date and time change would shorten the management period, such as when main purchase date and time 1 is moved back and main purchase date and time 2 is moved forward. Here, in S4 (FIG. 3), the system of the present invention sorts the inventory management sort information by purchase group and purchase date and time for necessary ingredient information in which a purchase date and time have been registered based on the necessary ingredient information storing means. The cooking end date and time, or the cooking date and time with the maximum value (latest value), is determined for the inventory management sort information, and it is determined whether or not the conditions “purchase date and time<main purchase date and time 1” and “main purchase date 1≦cooking end date and time” have been satisfied. In other words, it is determined whether or not all times in the inventory presence period, which is the period from the purchase date and time to the cooking end date and time, are within the management period. When this condition has been satisfied, the inventory management information is edited so that the inventory management sort information (the inventory management sort information used to support the management period purchasing style) can be identified (differentiated) from inventory management sort information that does not satisfy the condition. This is displayed in i11_2 (FIG. 11). Here, as mentioned earlier, “main purchase date and time 1<main purchase date and time 2” and “purchase date and time≦cooking date and time” are both true.

In this way, inventory management sort information (inventory aggregate information) in which the inventory presence information, which is the period from the purchase date and time to the cooking end date and time, straddles more than one management period, can be used as inventory management sort information (inventory aggregate information) used to assist with the management period purchasing style.

In other words, in situations in which the management period used to determine the purchase date and time registerable necessary ingredient information cannot be changed after a purchase date and time have been registered for the purchase date and time registerable necessary ingredient information, inventory management sort information satisfying the condition “a time in the inventory presence period, which is the period from the purchase date and time to the cooking end date and time, is within the management period” can be merged with inventory management sort information satisfying the condition “all times in the inventory presence period, which is the period from the purchase date and time to the cooking end date and time, are within the management period”.

The inventory management sort information can be prepared beforehand and stored in a database or file.

At this time, the inventory decision reference date and time i11_3 (FIG. 11) can be a value indicated by the user, the main purchase date and time 1, a date and time near the CPU date and time, or the final date and time in the management period beginning with the main purchase date and time 1.

Here, the inventory decision reference date and time are the reference date and time from when the user checked the inventory status. For example, “2008/05/17 before lunch” is indicated in i11_3 (FIG. 11) of the inventory management information screen (FIG. 11) when the inventory status is to be checked immediately before lunch on 2008/05/17.

At this time, the inventory management sort information can include inventory aggregate information used to support the management period purchasing style. This information is aggregated by purchase group and purchase date and time so that the user can check the management presence period, which is the period from the purchase date and time to the cooking end date and time.

In S2 (FIG. 3), the available purchase period (described below) is always used to store purchase dates and times satisfying condition (a) or (b).

(a) “Main Purchase Date and Time 1≦Purchase Date and Time≦Cooking Date and Time<Main Purchase Date and Time 2”

(b) “Cooking Date and Time−Available Purchase Period≦Purchase Date and Time≦Cooking Date and Time”

In S4 (FIG. 3), when necessary ingredient information linked to a purchase date and time are sorted by purchase group and purchase date and time as inventory management sort information, necessary ingredient information satisfying at least one of (c) through (g) is extracted.

(c) “Purchase Date and Time<Main Purchase Date and Time<Cooking Date and Time<Main Purchase Date and Time 2”

(d) “Main Purchase Date and Time 1≦Purchase Date and Time≦Cooking Date and Time<Main Purchase Date and Time 2”

(e) “Main Purchase Date and Time 1≦Purchase Date and Time<Main Purchase Date and Time 2 Cooking Date and Time”

(f) “Purchase Date and Time<Main Purchase Date and Time 1<Main Purchase Date and Time 2≦Cooking Date and Time”

(g) “Main Purchase Date and Time 1−Available Purchase Period≦Purchase Date and Time≦Cooking Date and Time<Main Purchase Date and Time 1”

When this extracted necessary ingredient information is sorted by purchase group and purchase date and time, the amount of processing can be reduced, and the processing burden can be lightened.

Here, the available purchase period allows for a purchase at a maximum before the cooking date and time. In other words, it is a period in which the cooking date and time are the end point and a purchase must be made before the cooking date and time. For example, this is from 30 days to 40 days in the second operational example. The available purchase period in the second operational example has to be up to the maximum value obtainable within the management period (the period between main purchase date and time 1 and main purchase date and time 2). This is because when the available purchase period is shorter than the management period and the purchase date and time for a necessary ingredient is the initial date and time in the management period such as the main purchase date and time, the condition in (b) cannot be satisfied.

When the purchase date and time can be registered for just the purchase date and time registerable necessary ingredient information in S2 (FIG. 3), the stored purchase date and time always satisfies the condition “main purchase date and time 1≦purchase date and time≦main purchase date and time 2” in (a).

Inventory management sort information satisfying the conditions “purchase date and time<main purchase date and time 2” and “main purchase date and time 1≦cooking end date and time” (i.e., satisfying the condition “a time in the inventory presence period, which is the period from the purchase date and time to the cooking end date and time, is within the management period”) is classified by (a) through (h) below.

(a) If “main purchase date and time 1≦purchase date and time<cooking start date and time<main purchase date and time 2”, then this-period purchase/this-period cooking starts/this-period cooking ends.

(b) If “main purchase date and time 1≦purchase date and time≦cooking start date and time<main purchase date and time 2≦cooking end date and time”, then this-period purchase/this-period cooking starts/next-period cooking ends.

(c) If “main purchase date and time 1≦purchase date and time<main purchase date and time 2≦cooking start date and time≦cooking end date and time”, then this-period purchase, next-period cooking starts/next-period cooking ends.

(d) If “purchase date and time≦cooking start date and time<main purchase date and time 1≦cooking end date and time<main purchase date and time 2”, then prior-period purchase, prior-period cooking starts/this-period cooking ends.

(e) If “purchase date and time<main purchase date and time 1≦cooking start date and time≦cooking end date and time<main purchase date and time 2”, then prior-period purchase/this-period cooking starts/this-period cooking ends.

(f) If “purchase date and time<cooking start date and time<main purchase date and time 1<main purchase date and time 2≦cooking end date and time”, then prior-period purchase, prior-period cooking starts/next-period cooking ends.

(g) If “purchase date and time<main purchase date and time 1≦cooking start date and time<main purchase date and time 2≦cooking end date and time”, then prior-period purchase/this-period cooking starts/next-period cooking ends.

(h) If “purchase date and time<main purchase date and time 1<main purchase date and time 2≦cooking start date and time≦cooking end date and time”, then prior-period purchase, next-period cooking starts/next-period cooking ends.

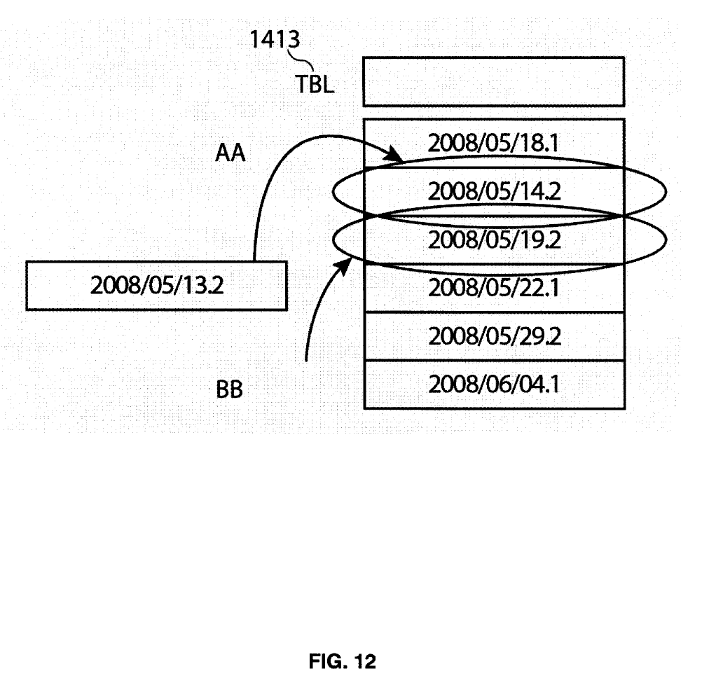

The following is an explanation using FIG. 12 through FIG. 14 of a specific example of display content when the management period may be changed.

FIG. 12 is an example of a management table 1413 in which the management period may be changed. Here, 2008/05/13 before dinner is changed to 2008/05/14 before dinner, and 2008/05/19 before dinner is added. For example, at this time, there is a pattern in which the management period to which the change and addition have been applied satisfies the condition “2008/05/14 before dinner≦management period<2008/05/19 before dinner” is changed from a management period satisfying the condition “2008/05/13 before dinner≦management period<2008/05/22 before lunch”. Also, there is a pattern in which a management period satisfying the condition “2008/05/8 before 5 management period<2008/05/14 before dinner” is changed from a management period satisfying the condition “2008/05/8 before lunch 5 management period<2008/05/13 before dinner”.

FIG. 13 is an example of a purchase date and time registration information screen in which the management period has been changed from “2008/05/13 before dinner 5 management period<2008/05/22 before lunch” to “2008/05/14 before dinner 5 management period<2008/05/19 before dinner”. (a) and (b) below are edited in FIG. 10.

(a) Necessary ingredient information satisfying the conditions “purchase date and time not registered” and “main purchase date and time 1≦cooking date and time<main purchase date and time 2”.

(b) Necessary ingredient information satisfying the conditions “purchase date and time registered” and “main purchase date and time 1≦purchase date and time≦cooking date and time<main purchase date and time 2”.

Also, (c) through (e) below are extracted in FIG. 13 and edited as purchase date and time registration information.

(c) Necessary ingredient information (illustrated example: i13_4) satisfying the conditions “purchase date and time registered” and “purchase date and time<main purchase date and time 1<main purchase date and time 2≦cooking date and time”.

(d) Necessary ingredient information (illustrated example: i13_5) satisfying the conditions “purchase date and time registered” and “main purchase date and time 1≦purchase date and time<main purchase date and time 2≦cooking date and time”.

(e) Necessary ingredient information (illustrated example: i13_3) satisfying the conditions “purchase date and time registered” and “purchase date and time<main purchase date and time 1≦cooking date and time<main purchase date and time 2”.

In the purchase date and time registration information screen, the user can identify necessary ingredient information in which the purchase date and time and the cooking date and time straddle more than one management period, which may have occurred because of a change in the management period as described above. In FIG. 13, “(prior)” means a prior management period, and “(next)” means a subsequent management period.

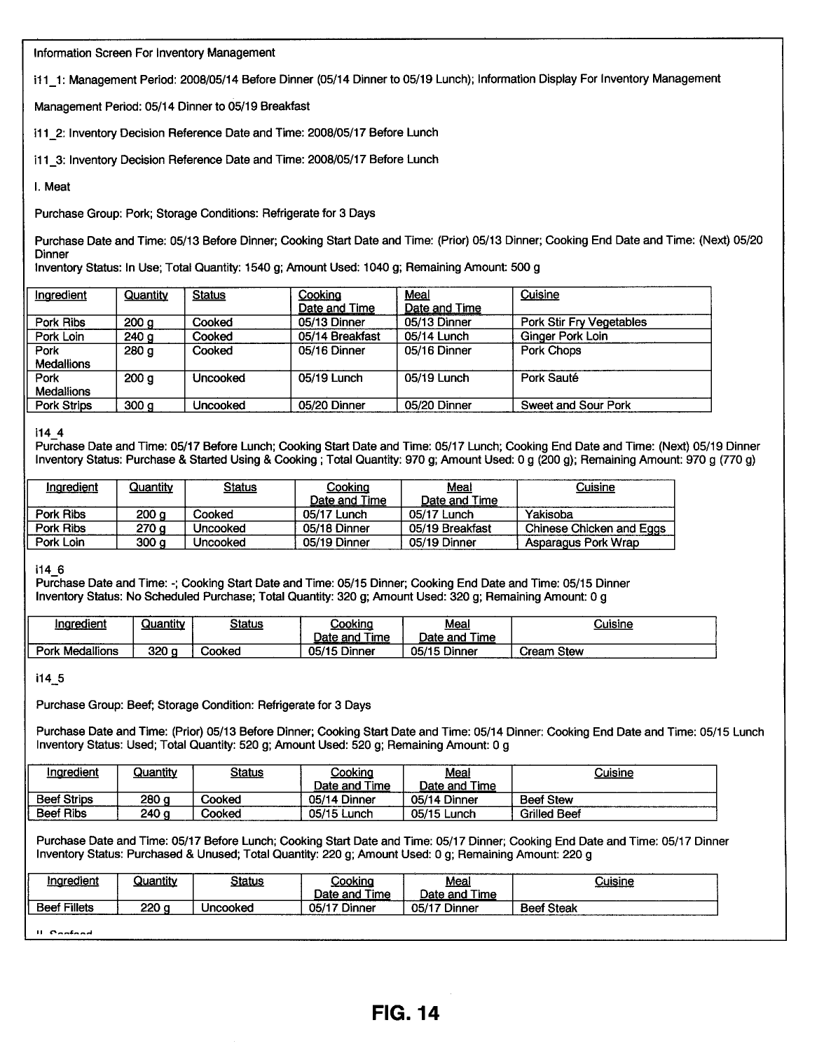

FIG. 14 is an example of an inventory management information screen in which the management period may be changed. (a) below is edited in FIG. 11.

(a) Inventory management sort information satisfying the condition “main purchase date and time 1≦purchase date and time≦cooking start date and time<main purchase date and time 2”, or “this-period purchase/this-period cooking starts/this-period cooking ends.”

Also, (b) through (d) below are extracted in FIG. 14 and edited as inventory check information.

(b) Inventory management sort information (illustrated example: i14_3) satisfying the condition “purchase date and time≦cooking start date and time<main purchase date and time 1<main purchase date and time 2≦cooking end date and time”, or “prior-period purchase/prior-period cooking starts/next-period cooking ends.”

(c) Inventory management sort information (illustrated example: i14_4) satisfying the condition “main purchase date and time 1≦purchase date and time≦cooking start date and time<main purchase date and time 2≦cooking end date and time”, or “this-period purchase/this-period cooking starts/next-period cooking ends”.

(d) Inventory management sort information (illustrated example: i14_5) satisfying the condition “purchase date and time<main purchase date and time 1≦cooking start date and time≦cooking end date and time<main purchase date and time 2”, or “prior-period purchase/this-period cooking starts/this-period cooking ends”.

In the inventory management information screen, the user can determine inventory management sort information (inventory aggregate information) in which the inventory presence period from the purchase date and time to the cooking end date and time straddles more than one management period, which may have occurred because of a change in the management period as described above, as inventory management sort information (inventory aggregate information) for assisting with the management period purchasing style. In FIG. 14, “(prior)” means a prior management period, and “(next)” means a subsequent management period.

When the inventory decision reference date and time i11_3 has been changed, the affected sections in the inventory management information is edited once again and displayed in i14_2 (or i11_2).

### 3.2.6. Handling Necessary Ingredient Information Without a Registered Purchase Date and Time in Inventory Check Information

In S4 (FIG. 3), necessary ingredient information satisfying the conditions “no purchase date and time registered, and main purchase date and time 1≦cooking date and time<main purchase date and time 2” is extracted from the necessary ingredient information storing means. This information is sorted by purchase group (because the purchase date and time are a NULL value in the actual processing, it can be sorted by purchase date and purchase date and time), and necessary ingredient sort information with no purchase plans are edited as a portion of the inventory management information. The necessary ingredient information with no purchase plans is edited by attaching “no scheduled purchase”, and edited in i11_2 (FIG. 11) and i14_2 (FIG. 14). i11_4 (FIG. 11) and i14_6 (FIG. 14) are display examples.

Using the inventory management information screen, the user can manage necessary ingredient information with no registered purchase date and time in the management period, and determine which necessary ingredients have no purchase plans.

### 3.3. Operational Example 3

The third operational example of the present invention is used to assist with the day-to-day purchasing style described above (a purchasing style in which the user goes shopping daily to procure fresh ingredients).

### 3.3.1. Purchase Date and Time Registration Information Editing Means

FIG. 15 is an example of a purchase date and time registration information screen in the third operational example. Initially, the purchase date and time registration information display section i15_2 is blank, and the date and time one day before and seven days after the CPU date and time are loaded. The user selects a purchase date and time in i15_1 (FIG. 15), and presses the purchase date and time registration information display button. Here, the purchase reference date and time are the date and time for referencing a purchase (shopping). For example, in the purchase date and time registration information screen (FIG. 15), when a necessary ingredient is selected for purchase immediately before preparation of lunch on 2008/05/13, 2008/05/13 before lunch is indicated in i15_1 (FIG. 15).

Then, in S1 (FIG. 3), the system of the present invention receives the purchase date and time selected in i15_1 (FIG. 15). Next, the system of the present invention extracts from the necessary ingredient information storing means necessary ingredient information satisfying the condition “purchase reference date and time within the available purchase period”, edits the purchase date and time registration information, and displays the information in i15_2 (FIG. 15).

Here, the available purchase period allows for a purchase at a maximum before the cooking date and time. In other words, it is a period in which the cooking date and time are the end point and a purchase must be made before the cooking date and time. In this embodiment, the available purchase period is nine days including the actual day of the cooking date and time (or eight days excluding the actual day of the cooking date and time). In other words, the available purchase period for each necessary ingredient is a period that satisfies the condition “cooking date and time−available purchase period (eight-day period)≦purchase reference date and time≦cooking date and time”. Stated in reverse, the extraction conditions mentioned above are the same as those for extracting necessary ingredient information satisfying the condition “the cooking date and time are within the available purchase period (nine-days) calculated from the purchase reference date and time” or “purchase reference date and time≦cooking date and time≦purchase reference date and time+available purchase period (eight-day period)”. The available purchase period does not have to be the same for all purchase groups and necessary ingredients. It can be set for each purchase group and each necessary ingredient. For example, a value extracted from the quality assurance period linked to a purchase group ID or necessary ingredient can be used. The value can also be changed depending on the season.

Next, it is determined whether or not each extracted necessary ingredient satisfies the condition “the purchase reference date and time are within the available purchase period”. (In the third operational example, in addition to this condition, the necessary ingredient information with a registered purchase date and time have to satisfy the condition using pattern (a) described above in order to prevent easy overwrite. (In other words, the registered purchase date and time have to satisfy the condition “purchase date and time≧purchase reference date and time”. When satisfied, the purchase date and time registration information is edited and displayed in i15_2 (FIG. 15) so that it can be identified (differentiated) from other necessary ingredient information as purchase date and time registerable necessary ingredient information for assisting with the day-to-day purchasing style (referred to below as the “purchase date and time registerable necessary ingredient information”). In this way, the user can recognize purchase date and time registerable necessary ingredient information using the purchase date and time registration information screen (FIG. 15). Here, the purchase date and time registerable necessary ingredient information used to assist with the day-to-day purchasing style is necessary ingredient information that can register the purchase reference date and time as the purchase date and time (or update it if the purchase date and time have already been registered) to assist with the day-to-day purchasing style. In the purchase date and time registration information screen (FIG. 15), there is a checkbox in i15_3 (FIG. 15) for purchase date and time registerable necessary ingredient information. Because the checkbox is not displayed for other necessary ingredient information, the purchase reference date and time cannot be registered as the purchase date and time for them. By editing information so that only purchase date and time registerable necessary ingredient information can be registered using the purchase reference date and time, the user can only register purchase date and time registerable necessary ingredient information using the purchase reference date and time. The font color or the background color can also be changed. In FIG. 15, a checkbox is displayed for all of the necessary ingredient information. Therefore, FIG. 16 should be referenced as an example of a purchase date and time registration information screen for the same third operational example because the purchase date and time registration information screen has different purchase reference dates and times.

The necessary ingredient information can essentially be displayed freely in the purchase date and time registration information screen. However, the necessary ingredient information should satisfy the extraction condition “the purchase reference date and time are within the management period.” It can also be purchase date and time registerable necessary ingredient information only. Because only purchase date and time registerable necessary ingredient information is displayed, no contrivances such as the addition of marks or changes in background color are necessary to identify (differentiate) purchase date and time registerable necessary ingredient information. Of course, other necessary ingredient information can be displayed. However, the purchase date and time registerable necessary ingredient information should be identified (differentiated).

In order to prevent easy overwriting, necessary ingredient information with a registered purchase date and time must satisfy the condition “the purchase reference date and time are within the available purchase period”. In addition necessary ingredient information with a registered purchase date and time must satisfy either (a) or (b) below.

(a) The registered purchase date and time satisfy “purchase date and time≧purchase reference date and time”.

(b) The registered purchase date and time satisfy “purchase date and time=purchase reference date and time”.

When this is satisfied, the registered purchase date and time can be overwritten by the purchase reference date and time. In other words, it is purchase date and time registerable necessary ingredient information. Either (a) or (b) can be used, depending on which method is easier. Alternately, when “purchase date and time>purchase reference date and time” in pattern (a), the purchase date and time can be overwritten with the purchase reference date and time. It can be prohibited in the case of pattern (b).

In the third operational example, pattern (a) is used on necessary ingredient information with a registered purchase date and time to prevent easy overwrites. When, in the case of each necessary ingredient extracted from the necessary ingredient information storing means, “the purchase date and time have been registered, and purchase date and time<purchase reference date and time”, it is determined in S1 (FIG. 3) that the ingredient has been purchased. A “Y” is added in i16_3 (FIG. 16). A display example is not shown in FIG. 15. In FIG. 16, i16_3 (FIG. 16) is a display example. Necessary ingredient information with a “Y” is not purchase date and time registerable necessary ingredient information.

### 3.3.2. Purchase Date and Time Registering Means

Next, in S2 (FIG. 3) of the system of the present invention, the user uses the input means 12 to input information specifying purchase date and time registerable necessary ingredient information for purchase on the purchase reference date and time among the purchase date and time registerable necessary ingredient information identifiable on the purchase date and time registration information screen (FIG. 15). In i15_3 (FIG. 15) of this embodiment, it is selected (inputted) by checking the checkbox of the necessary ingredient to be purchased on the purchase reference date and time indicated by i15_1 (FIG. 15). Basically by allowing the purchase date and time to be registered only for purchase date and time registerable necessary ingredient information, the purchase reference date and time can be registered by the user as the purchase date and time for purchase date and time registerable necessary ingredient information. Next, the purchase reference date and time are linked to the purchase date and time registerable necessary ingredient information based on the inputted information, and the linked information is stored. Usually, the purchase reference date and time are a purchase date and time satisfying the condition “within the available purchase period” or “cooking date and time−available purchase period≦purchase date and time≦cooking date and time”. This is linked to the selected purchase date and time registerable necessary ingredient information, and the linked information is stored. When the data is stored in a server 3, the validity of the values should also be checked by the server 3.

The registered purchase date and time are displayed in the section corresponding to i15_4 (FIG. 15). When unchecked, a NULL value is stored in the purchase date and time attributes linked to the corresponding necessary ingredient information in menu-necessary ingredient TBL 1412. At the same time, a minus (−) sign is added to the section corresponding to i15_4 (FIG. 15).

Simply by selecting the purchase date and time registerable necessary ingredient information for purchase on the purchase reference date and time indicated in i15_1 (FIG. 15), a purchase date and time satisfying the necessary conditions can be registered. In this way, an effective purchase date and time can be registered. When the purchase date and time registration information screen (FIG. 4) in the first operational example is used, the user has to register a date and time while being mindful of which necessary ingredients are to be purchased. In the third operational example, as in the second operational example, by contrast, the user does not have to think about which necessary ingredients are to be purchased at the purchase reference date and time. This simplifies the decision-making process for the user.

In the purchase date and time registration method, as in the second operational example, information specifying a necessary ingredient and the purchase date and time does not have to be received. Information able to specify the purchase date and time corresponding to each necessary ingredient can be used. The system of the present invention can also use pre-stored information and algorithms to specify the purchase date and time corresponding to each necessary ingredient. For example, an automatic selection mechanism can be realized using an algorithm as explained below.

The quality assurance period is stored in the purchase group TBL 1414 or the menu-necessary ingredient TBL 1412, so the quality assurance period linked to the necessary ingredients is stored. i15_6 (FIG. 15) shows the quality assurance period stored in the system of the present invention. When the user selects the purchase reference date and time in i15_1 (FIG. 15) and presses the automatic selection button i15_5 (FIG. 15), the system of the present invention links it to necessary ingredient information satisfying the condition “purchase date and time not registered, purchase date and time within management period, and (purchase reference date and time≦cooking date and time≦purchase reference date and time+quality assurance period)”. The purchase reference date and time are then stored as the purchase date and time, and the purchase date and time are displayed in the section corresponding to i15_4 (FIG. 15). When the automatic selection button i15_5 (FIG. 15) is pressed under conditions other than “purchase reference date and time≦cooking date and time≦purchase reference date and time+quality assurance period”, the purchase group ID can be received, and the condition “purchase group ID matches” added.

### 3.3.3. Purchase Information Editing Means

When the user pushes the purchase information display button i15_13 (FIG. 15), the purchase reference date and time indicated in i10_3 (FIG. 10) is set as the purchase date and time, and purchase information is acquired in the same manner as i5_2 in the purchase information screen (FIG. 5). The details of this process are similar to those in “3.1.4 Purchase Information Editing Means”. It is also similar in that the purchase date and time registration information and the purchase information (or the inventory management information and the purchase information) are displayed on the same screen. (The purchase information is displayed using the purchase date and time registration information (or the inventory management information)).

### 3.3.4. Inventory Management Information Editing Means

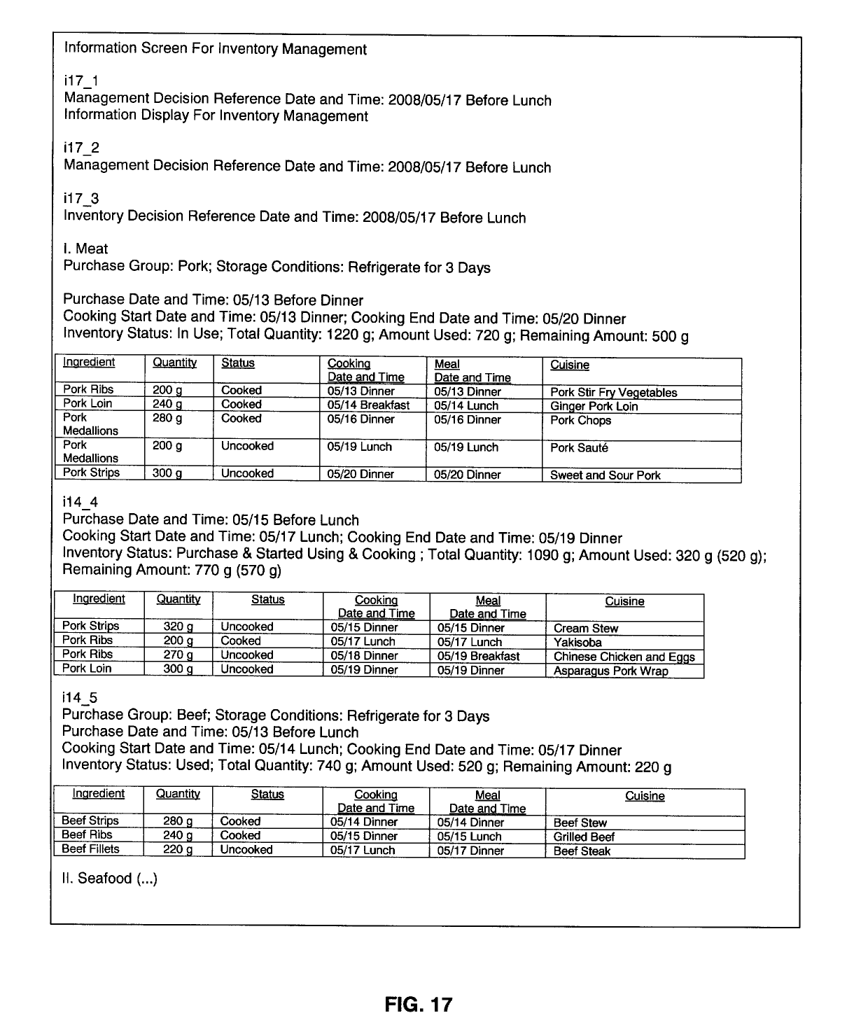

FIG. 17 is an example of an inventory management information screen in the third operational example. Initially, the inventory management information display section i17_2 (FIG. 17) is blank, and a date and time three days before the CPU date and time are loaded as the inventory decision reference date and time in the inventory decision reference date and time i171 (FIG. 17). The user selects a management decision reference date and time for i17_1 (FIG. 17), and presses the inventory management information display button.

Here, the inventory decision reference date and time are the date and time serving as a decision reference when the user checks the inventory status. For example, when the inventory status is to be checked prior to cooking lunch on 2008/05/17 in the inventory management information screen (FIG. 17), “2008/05/17 before lunch” is set in i7_1 (FIG. 7).

Then, in S4 (FIG. 3), the system of the present invention receives the inventory decision reference date and time selected in i17_1 (FIG. 17). Next, the necessary ingredient information with a registered purchase date and time are sorted by purchase group and purchase date and time based on the necessary ingredient information storing means as inventory management sort information. The cooking end time, or the latest (maximum value) cooking date and time are determined in the inventory management sort information, and it is determined whether or not the inventory decision reference date and time are within a period from “purchase date and time−specified period prior to inventory presence period” to “cooking end date and time+specified period after inventory presence period” (referred to below as the “inventory management sort information specified period”). In other words, it is determined whether or not “purchase date and time−specified period before inventory presence period≦inventory decision reference date and time≦cooking end date and time+specified period after inventory presence period”. When this condition is satisfied, the inventory management information is edited and displayed in i17_2 (FIG. 17) so that the inventory management sort information (inventory management sort information used to assist with the day-to-day purchasing style) can be identified (differentiated) from inventory management sort information that does not satisfy the condition.

Here, the specified period before the inventory presence period is a period used by the inventory management information editing means (S4 (FIG. 3)) to identify (differentiate) inventory management sort information by the extent to which it is prior to the inventory presence period. Also, the specified period after the inventory presence period is a period used by the inventory management information editing means (S4 (FIG. 3)) to identify (differentiate) inventory management sort information (or inventory aggregate information) by the extent to which it is after the inventory presence period. The specified period before the inventory presence period and the specified period after the inventory presence period can be zero days.

At this time, the inventory management sort information can include inventory aggregate information for assisting with the day-to-day purchasing style, which is information aggregated by purchase group and purchase date and time allowing the user to at least check the inventory presence period, which is the period from the purchase date and time to the cooking end date and time. (This is referred to below simply as the “inventory aggregate information”.)

The inventory management sort information can be prepared beforehand and stored in a database or file.

The display content in FIG. 17 will now be explained using FIG. 15 through FIG. 17. Like FIG. 15, FIG. 16 is an example of a purchase date and time registration information screen. The purchase reference date and time are 2008/05/15 before dinner. In FIG. 15, the purchase reference date and time are 2008/05/13 before lunch, which is one difference. In FIG. 17, the inventory management sort information displayed in i17_3 and i17_5 corresponds to the inventory management sort information for the necessary ingredient information having a registered purchase date and time in FIG. 15. The inventory management sort information displayed in i17_4 corresponds to the inventory management sort information for the necessary ingredient information having a registered purchase date and time in FIG. 16.

When the purchase date and time can be registered for just the purchase date and time registerable necessary ingredient information in S2 (FIG. 3), the stored purchase date and time always satisfies the condition “cooking date and time−available purchase period (eight-day period in the third operational example)≦purchase date and time≦cooking date and time”. Thus, only necessary ingredient information with a registered purchase date and time satisfying the condition “inventory decision reference date and time−available purchase period (eight-day period in the third operational example)−specified period before inventory presence period≦purchase date and time≦inventory decision reference date and time+specified period after inventory presence period” is extracted in S4 (FIG. 3). When this extracted necessary ingredient information is sorted by purchase ID and purchase date and time, the amount of processing can be reduced, and the processing burden can be lightened.

### INDUSTRIAL APPLICABILITY

The present invention can be used by a person who cooks everyday such as a housewife to purchase necessary ingredients and manage an inventory of purchased ingredients based on a menu plan.

### KEY TO THE FIGURES

1 . . . . Information Processing Device
11 . . . . Display Device
12 . . . . Input Device
13 . . . . Arithmetic Device
14 . . . . Storage Device
15 . . . . Communication Interface (I/F)
16 . . . . Bus
2 . . . . Communication Network
3 . . . . Server
4 . . . . Portable Information Terminal

1. A cooking support system for providing a meal planning and management support function, an ingredient purchase support function, and an inventory management support function, characterized in comprising:
a computer processor means for data processing, a recording medium, a recording means for recording data on the recording medium, a display means for outputting processing results, and an input means for inputting information to the cooking support system, the cooking support system further comprising:
a necessary ingredient information storing means for storing in the recording medium as menu planning information at least necessary ingredient information being information on the ingredients necessary for cooking, the necessary ingredient information being linked to the cooking date and time and to a purchasing table assembling ingredients based on an assembly of one or more substitutable ingredients;
a purchase date and time registration information editing means using the computer processor means to edit based on the necessary ingredient information storing means the necessary ingredient information as purchase date and time registration information being information to be referenced when the user registers the purchase date and time, and to output the edited information from the display means;
a purchase date and time registration means allowing the user to input from the input means information identifying the purchase date and time corresponding to the necessary ingredient information while referencing the purchase date and time registration information, and storing in the necessary ingredient information storing means purchase dates and times being dates and times prior to the cooking dates and times linked to the necessary ingredient information based on inputted information and using the recording means;
a purchase information editing means using the computer processor means to edit purchase information to be referenced when the user makes purchases based on the necessary ingredient information storing means so information related to necessary ingredients can be identified by purchase group and purchase date and time, and to output the edited information from the display means; and
an inventory management information acquiring means for acquiring the final cooking date and time within the cooking dates and times linked to necessary ingredient information linked, in turn, to the same purchase group and purchase date and time as the cooking end date and time being the date and time the necessary ingredient is to run out in the inventory based on the necessary ingredient information storing means using a computer processor means.

2. The cooking support system of claim 1 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date, and for not changing the management period after being linked to necessary ingredients whose purchase date and time are registerable and the purchase dates and times have been stored;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not all times within the inventory presence period are within the management period, and when the condition is satisfied edits the information so as to be identifiable as inventory aggregate information for supporting a management period purchasing style.

3. The cooking support system of claim 1 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for indentifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not a certain time within the inventory presence period is within the management period, and when the condition is satisfied edits the information so as to be identifiable as inventory aggregate information for supporting a management period purchasing style.

4. The cooking support system of claim 1 for supporting a day-to-day purchasing style being a purchasing style for purchasing fresh ingredients on a daily basis;
wherein the purchase date and time registration information editing means uses purchase reference dates and times being dates and times for purchase reference;
wherein the computer processor means based on the necessary ingredient information storing means and the necessary ingredient information at least determines whether or not a condition is satisfied being that the purchase reference dates and times are within the management period, the purchase date and time registration information being edited when the condition is satisfied so as to be identified as necessary ingredient information in which the purchase dates and times can be registered or updated as purchase dates and times, or as purchase date and time registerable necessary ingredient information for supporting a day-to-day purchasing style;
wherein the purchase date and time registration means allows the user to input from the input means information for indentifying purchase date and time registerable necessary ingredient information for purchases at the purchase reference dates and times among the identifiable purchase date and time registerable necessary ingredient information, the purchase date and time registration means using the input means and input information to link purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means, the inventory aggregate information, and inventory decision reference dates and times being dates and times referenced for decisions when verifying inventory status, at least whether or not the inventory decision reference dates and times are within the period from (purchase dates and times minus specified period prior to inventory presence period) to (cooking end dates and times plus specified period prior to inventory presence period), and when the condition is satisfied edits the information so as to be identifiable as inventory aggregate information for supporting a day-to-day purchasing style.

5. A cooking support program for providing a meal planning and management support function, an ingredient purchase support function, and an inventory management support function, characterized in comprising:
a computer having a computer processor means for data processing, a recording medium, a recording means for recording data on the recording medium, a display means for outputting processing results, and an input means for inputting information to the cooking support system being operated to provide:
a necessary ingredient information storing means for storing in the recording medium as menu planning information at least necessary ingredient information being information on the ingredients necessary for cooking, the necessary ingredient information being linked to the cooking date and time and to a purchasing table assembling ingredients based on an assembly of one or more substitutable ingredients;
a purchase date and time registration information editing means using the computer processor means to edit based on the necessary ingredient information storing means the necessary ingredient information as purchase date and time registration information being information to be referenced when the user registers the purchase date and time, and to output the edited information from the display means;
a purchase date and time registration means allowing the user to input from the input means information identifying the purchase date and time corresponding to the necessary ingredient information while referencing the purchase date and time registration information, and storing in the necessary ingredient information storing means purchase dates and times being dates and times prior to the cooking dates and times linked to the necessary ingredient information based on inputted information and using the recording means;
a purchase information editing means using the computer processor means to edit purchase information to be referenced when the user makes purchases based on the necessary ingredient information storing means so information related to necessary ingredients can be identified by purchase group and purchase date and time, and to output the edited information from the display means; and
an inventory management information acquiring means for acquiring the final cooking date and time within the cooking dates and times linked to necessary ingredient information linked, in turn, to the same purchase group and purchase date and time as the cooking end date and time being the date and time the necessary ingredient is to run out in the inventory based on the necessary ingredient information storing means using a computer processor means.

6. The cooking support program of claim 5 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date, and for not changing the management period after being linked to necessary ingredients whose purchase date and time are registerable and the purchase dates and times have been stored;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not all times within the inventory presence period are within the management period, and when the condition is satisfied edits the information so as to be identifiable as inventory aggregate information for supporting a management period purchasing style.

7. The cooking support program of claim 5 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not a certain time within the inventory presence period is within the management period, and when the condition is satisfied edits the information so as to be identifiable as inventory aggregate information for supporting a management period purchasing style.

8. The cooking support program of claim 5 for supporting a day-to-day purchasing style being a purchasing style for purchasing fresh ingredients on a daily basis;
wherein the purchase date and time registration information editing means uses purchase reference dates and times being dates and times for purchase reference;
wherein the computer processor means based on the necessary ingredient information storing means and the necessary ingredient information at least determines whether or not a condition is satisfied being that the purchase reference dates and times are within the management period, the purchase date and time registration information being edited when the condition is satisfied so as to be identified as necessary ingredient information in which the purchase dates and times can be registered or updated as purchase dates and times, or as purchase date and time registerable necessary ingredient information for supporting a day-to-day purchasing style;
wherein the purchase date and time registration means allows the user to input from the input means information for identifying purchase date and time registerable necessary ingredient information for purchases at the purchase reference dates and times among the identifiable purchase date and time registerable necessary ingredient information, the purchase date and time registration means using the input means and input information to link purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means, the inventory aggregate information, and inventory decision reference dates and times being dates and times referenced for decisions when verifying inventory status, at least whether or not the inventory decision reference dates and times are within the period from (purchase dates and times minus specified period prior to inventory presence period) to (cooking end dates and times plus specified period prior to inventory presence period), and when the condition is satisfied edits the information so as to be identifiable as inventory aggregate information for supporting a day-to-day purchasing style.

9. A recording medium storing a cooking support program for providing a meal planning and management support function, an ingredient purchase support function, and an inventory management support function, characterized in comprising:
a computer having a computer processor means for data processing, a recording medium, a recording means for recording data on the recording medium, a display means for outputting processing results, and an input means for inputting information to the cooking support system being operated to provide:
a necessary ingredient information storing means for storing in the recording medium as menu planning information at least necessary ingredient information being information on the ingredients necessary for cooking, the necessary ingredient information being linked to the cooking date and time and to a purchasing table assembling ingredients based on an assembly of one or more substitutable ingredients;
a purchase date and time registration information editing means using the computer processor means to edit based on the necessary ingredient information storing means the necessary ingredient information as purchase date and time registration information being information to be referenced when the user registers the purchase date and time, and to output the edited information from the display means;
a purchase date and time registration means allowing the user to input from the input means information identifying the purchase date and time corresponding to the necessary ingredient information while referencing the purchase date and time registration information, and storing in the necessary ingredient information storing means purchase dates and times being dates and times prior to the cooking dates and times linked to the necessary ingredient information based on inputted information and using the recording means;
a purchase information editing means using the computer processor means to edit purchase information to be referenced when the user makes purchases based on the necessary ingredient information storing means so information related to necessary ingredients can be identified by purchase group and purchase date and time, and to output the edited information from the display means; and
an inventory management information acquiring means for acquiring the final cooking date and time within the cooking dates and times linked to necessary ingredient information linked, in turn, to the same purchase group and purchase date and time as the cooking end date and time being the date and time the necessary ingredient is to run out in the inventory based on the necessary ingredient information storing means using a computer processor means.

10. A recording medium storing the cooking support program of claim 9 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date, and for not changing the management period after being linked to necessary ingredients whose purchase date and time are registerable and the purchase dates and times have been stored;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not all times within the inventory presence period are within the management period, and when the condition is satisfied edits the information so as to be identifiable as inventory aggregate information for supporting a management period purchasing style.

11. A recording medium storing the cooking support program of claim 9 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date;
wherein the cooking support system has a management period storing means for storing a management period being the management reference period when the user purchases ingredients and manages inventory;
wherein the purchase date and time registration information editing means uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration means allows the user to input from the input means information for indentifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means and the inventory aggregate information at least whether or not a certain time within the inventory presence period is within the management period, and when the condition is satisfied edits the information so as to be identifiable as inventory aggregate information for supporting a management period purchasing style.

12. A recording medium storing the cooking support program of claim 9 for supporting a day-to-day purchasing style being a purchasing style for purchasing fresh ingredients on a daily basis;
wherein the purchase date and time registration information editing means uses purchase reference dates and times being dates and times for purchase reference;
wherein the computer processor means based on the necessary ingredient information storing means and the necessary ingredient information at least determines whether or not a condition is satisfied being that the purchase reference dates and times are within the management period, the purchase date and time registration information being edited when the condition is satisfied so as to be identified as necessary ingredient information in which the purchase dates and times can be registered or updated as purchase dates and times, or as purchase date and time registerable necessary ingredient information for supporting a day-to-day purchasing style;
wherein the purchase date and time registration means allows the user to input from the input means information for identifying purchase date and time registerable necessary ingredient information for purchases at the purchase reference dates and times among the identifiable purchase date and time registerable necessary ingredient information, the purchase date and time registration means using the input means and input information to link purchase reference dates and times as purchase dates and times to the purchase date and time registerable necessary ingredient information and storing the linked information;
wherein the inventory management information acquiring means serves as an inventory management information editing means for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing means determines using the computer processor means, the inventory aggregate information, and inventory decision reference dates and times being dates and times referenced for decisions when verifying inventory status, at least whether or not the inventory decision reference dates and times are within the period from (purchase dates and times minus specified period prior to inventory presence period) to (cooking end dates and times plus specified period prior to inventory presence period), and when the condition is satisfied edits the information so as to be identifiable as inventory aggregate information for supporting a day-to-day purchasing style.

13. A cooking support method of claim 5 for providing a meal planning and management support function, an ingredient purchase support function, and an inventory management support function, characterized in comprising:
a computer having a computer processor means for data processing, a recording medium, a recording means for recording data on the recording medium, a display means for outputting processing results, and an input means for inputting information to the cooking support system being operated to provide:
a necessary ingredient information storing means for storing in the recording medium as menu planning information at least necessary ingredient information being information on the ingredients necessary for cooking, the necessary ingredient information being linked to the cooking date and time and to a purchasing table assembling ingredients based on an assembly of one or more substitutable ingredients;
a purchase date and time registration information editing step using the computer processor means to edit based on the necessary ingredient information storing means the necessary ingredient information as purchase date and time registration information being information to be referenced when the user registers the purchase date and time, and to output the edited information from the display means;
a purchase date and time registration step allowing the user to input from the input means information identifying the purchase date and time corresponding to the necessary ingredient information while referencing the purchase date and time registration information, and storing in the necessary ingredient information storing means purchase dates and times being dates and times prior to the cooking dates and times linked to the necessary ingredient information based on inputted information and using the recording means;
a purchase information editing step using the computer processor means to edit purchase information to be referenced when the user makes purchases based on the necessary ingredient information storing means so information related to necessary ingredients can be identified by purchase group and purchase date and time, and to output the edited information from the display means; and
an inventory management information acquiring step for acquiring the final cooking date and time within the cooking dates and times linked to necessary ingredient information linked, in turn, to the same purchase group and purchase date and time as the cooking end date and time being the date and time the necessary ingredient is to run out in the inventory based on the necessary ingredient information storing means using a computer processor means.

14. The cooking support method of claim 13 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date, and for not changing the management period after being linked to necessary ingredients whose purchase date and time are registerable and the purchase dates and times have been stored;
wherein the cooking support system has a management period storing means for storing a management period being the management reference period when the user purchases ingredients and manages inventory;
wherein the purchase date and time registration information editing step uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration step allows the user to input from the input means information for identifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring step serves as an inventory management information editing step for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing step determines using the computer processor means and the inventory aggregate information at least whether or not all times within the inventory presence period are within the management period, and when the condition is satisfied edits the information so as to be identifiable as inventory aggregate information for supporting a management period purchasing style.

15. The cooking support method of claim 13 for setting the management period being the management reference period when the user purchases ingredients and manages inventory, for purchasing necessary ingredients among the necessary ingredients used in cooking during the cooking period whose expiration deadline or freshness deadline is on the initial date and time of the management period, for supporting a management period purchasing style being a purchasing style for purchasing the remaining necessary ingredients at a later date;
wherein the cooking support system has a management period storing means for storing a management period being the management reference period when the user purchases ingredients and manages inventory;
wherein the purchase date and time registration information editing step uses management period purchase reference dates and times being dates and times within the management period for purchase reference;
wherein the computer processor means based on the necessary ingredient information storing means and the necessary ingredient information at least determines whether or not a condition is satisfied being that the cooking dates and times are within the management period and the purchase reference dates and times in the management period are before the cooking dates and times, the purchase date and time registration information being edited when the condition is satisfied so as to be identified as necessary ingredient information in which the purchase dates and times within the management period can be registered or updated as purchase dates and times, or as purchase date and time registerable necessary ingredient information for supporting a management period purchasing style;
wherein the purchase date and time registration step allows the user to input from the input means information for indentifying purchase date and time registerable necessary ingredient information for purchases at the management period purchase reference dates and times among the identifiable purchase date and time registerable necessary ingredient information, the purchase date and time registration means using the input means and input information to link management period purchase reference dates and times as purchase dates and times to the purchase date and time registerable necessary ingredient information and storing the linked information;
wherein the inventory management information acquiring step serves as an inventory management information editing step for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing step determines using the computer processor means and the inventory aggregate information at least whether or not a certain time within the inventory presence period is within the management period, and when the condition is satisfied edits the information so as to be identifiable as inventory aggregate information for supporting a management period purchasing style.

16. The cooking support method of claim 13 for supporting a day-to-day purchasing style being a purchasing style for purchasing fresh ingredients on a daily basis;
wherein the purchase date and time registration information editing step uses purchase reference dates and times being dates and times for purchase reference;
wherein the computer processor means based on the necessary ingredient information storing means and the necessary ingredient information at least determines whether or not a condition is satisfied being that the purchase reference dates and times are within the management period, the purchase date and time registration information being edited when the condition is satisfied so as to be identified as necessary ingredient information in which the purchase dates and times can be registered or updated as purchase dates and times, or as purchase date and time registerable necessary ingredient information for supporting a day-to-day purchasing style;
wherein the purchase date and time registration step allows the user to input from the input means information for indentifying purchase date and time registerable necessary ingredient information for purchases at the purchase reference dates and times among the identifiable purchase date and time registerable necessary ingredient information, the purchase date and time registration means using the input means and input information to link purchase reference dates and times as purchase dates and times to the purchase date and time registerable necessary ingredient information and storing the linked information;
wherein the inventory management information acquiring step serves as an inventory management information editing step for editing inventory aggregate information being information aggregated by purchase group and purchase date and time for verifying an inventory presence period being the period from the purchase date and time to the cooking date and time including at least the purchase date and time and the cooking end date and time;
and wherein the inventory management information editing step determines using the computer processor means, the inventory aggregate information, and inventory decision reference dates and times being dates and times referenced for decisions when verifying inventory status, at least whether or not the inventory decision reference dates and times are within the period from (purchase dates and times minus specified period prior to inventory presence period) to (cooking end dates and times plus specified period prior to inventory presence period), and when the condition is satisfied edits the information so as to be identifiable as inventory aggregate information for supporting a day-to-day purchasing style.
